(19) United States
(12) Patent Application Publication
(10) Pub. No.: US 2025/0292540 A1
(43) Pub. Date: Sep. 18, 2025

(54) SYSTEM AND METHOD OF OBTAINING AN OBJECT-OF-INTEREST FROM A 3D POINT CLOUD

(71) Applicant: APPLICATIONS MOBILES OVERVIEW INC., Montreal (CA)

(72) Inventors: Laurent JUPPE, Montreal (CA); Sherif Esmat Omar ABUELWAFA, Montreal (CA); Marie-Eve DESROCHERS, Montreal (CA); Annie-Pier LAVALLEE, Montreal (CA); Asma Iben HOURIIA, Montreal (CA); Bryan MARTIN, Montreal (CA)

(21) Appl. No.: 18/935,078

(22) Filed: Nov. 1, 2024

Related U.S. Application Data
(63) Continuation of application No. PCT/IB2023/054725, filed on May 5, 2023.

(30) Foreign Application Priority Data
May 6, 2022 (EP) 22172105.3

(51) Int. Cl. G06V 10/762; G06V 10/422; G06V 10/46; G06V 10/56

(52) U.S. Cl. CPC G06V 10/763; G06V 10/422; G06V 10/46; G06V 10/56

(57) ABSTRACT

Method and system for extracting an object-of-interest from a 3D point cloud prior to performing 3D operations onto the extracted object-of-interest are disclosed, the 3D point cloud including a plurality of data points. The method includes, accessing the 3D point cloud, in response to identifying a planar surface within the 3D point cloud, identifying first data points that define the planar surface, identifying second data points for which a distance to the planar surface is below a first distance threshold, identifying third data points for which a color distance to the planar surface is below a second distance threshold and removing the first, second and third data points from the 3D point cloud to create pre-curated 3D point cloud clusters. For each of the pre-curated 3D point cloud clusters, a corresponding cluster parameter. The object-of-interest is identified based on the calculated cluster parameters and 3D operations are performed thereon.

### CROSS-REFERENCE TO RELATED APPLICATIONS

The present patent application is a continuation application of the International Application No. PCT/IB2023/054725 filed on May 5, 2023, entitled “SYSTEM AND METHOD OF OBTAINING AN OBJECT-OF-INTEREST FROM A 3D POINT CLOUD”, which claims priority to European Patent Application No. 22172105.3 entitled “SYSTEM AND METHOD FOR REMOVING NOISE FROM A 3D POINT CLOUD”, filed May 6, 2022, the entirety of which is incorporated by reference herein.

### FIELD

The present technology relates to systems and methods of generating a 3D representation of an object, and in particular to obtaining an object-of-interest produced by scanning a 3D object.

### BACKGROUND

Three-dimensional (“3D”) digital data may be produced by a variety of devices that involve three-dimensional scanning or sampling and/or numerical modeling. In one example, 3D laser scanners generate 3D digital data. A long range laser scanner is fixed in one location and rotated to scan objects around it. Alternatively, a short-range laser scanner is mounted on a device that moves around an object while scanning it. In any of the scenarios, the location of each point scanned is represented as a polar coordinate since the angle between the scanner and the object and distance from the scanner to the object are known. The polar coordinates are then converted to 3D Cartesian coordinates and stored along with a corresponding intensity or color value for the data point collected by the scanner.

Other examples to generate 3D digital data are depth cameras or 3D scanner to generate 3D digital data by collecting a complete point set of (x, y, z) locations that represent the shape of an object. Once collected, these point sets, also known as 3D point clouds, are sent to an image rendering system, which then processes the point data to generate a 3D representation of the object.

Typical systems and methods to capture 3D point clouds and then generate 3D representation of the object require specialized, cumbersome and costly hardware equipment. To this end, there is an interest in developing cost effective systems and methods to generate 3D representation from 3D point clouds.

### SUMMARY

Implementations of the present technology have been developed based on developers' appreciation of at least one technical problem associated with the prior art solutions.

For example, even though the prior art suggests techniques to generate 3D point clouds, such techniques often require specialized, cumbersome and costly hardware equipment such as 3D laser scanners to produce a point cloud of sufficient quality to permit, e.g., generation of a 3D representation of an object. Even point clouds produced by such specialized hardware may still contain enough noise to cause difficulties in processing the point cloud. Additionally, it may be desirable to effectively filter out portions of a point cloud that are not related to an object of interest in the point cloud, such as a surface on which an object of interest is resting.

Additionally, it is now possible to use non-specialized hardware, such as a mobile device comprising a camera (e.g., an iPhone® from Apple or a Galaxy® from Samsung) to acquire a 3D point cloud. However, point clouds obtained from such non-specialized hardware may include even more noise than point clouds obtained using specialized 3D scanning hardware, making the improvement of a point cloud even more important.

In accordance with a first broad aspect of the present technology, there is provided a computer-implemented method for extracting an object-of-interest from a 3D point cloud prior to performing 3D operations onto the extracted object-of-interest, wherein the 3D point cloud is comprised of a plurality of data points. The method comprises accessing the 3D point cloud; where in response to identifying a planar surface within the 3D point cloud, identifying first data points that define the planar surface from the 3D point cloud; identifying second data points for which a distance to the planar surface is below a first distance threshold; identifying third data points for which a color distance to the planar surface is below a second distance threshold; and removing the first, second and third data points from the 3D point cloud to create pre-curated 3D point cloud clusters. For each of the pre-curated 3D point cloud clusters, the method further includes determining a corresponding cluster parameter, the corresponding cluster parameter being calculated based on a number of data points of the given 3D point cloud cluster, a location of a center of mass of the given 3D point cloud cluster, and a resolution of the given 3D point cloud cluster, and subsequently identifying the object-of-interest based on the calculated cluster parameters; and performing 3D operations on the object-of-interest.

In some non-limiting implementations, performing 3D operations on the object-of-interest includes performing geometric measurements thereon.

In some non-limiting implementations, performing 3D operations on the object-of-interest comprises morphing the object-of-interest onto a 3D model.

In some non-limiting implementations, a color distance between two data points is measured by comparing H-channel values within a Hue Saturation Value (HSV) color space of the two data points.

In some non-limiting implementations, the 3D point cloud may contain a planar surface that is comprised of first data points that define the planar surface from the 3D point cloud; second data points for which a distance to the planar surface is below a first distance threshold; and/or third data points for which a color distance to the planar surface is below a second distance threshold.

In some non-limiting implementations, the at least one pre-curated 3D point cloud cluster is obtained by removing the at least one planar surface comprised of the first, second and third data points within the 3D point cloud.

In some non-limiting implementations, where a distance between two pre-curated 3D point cloud clusters is below a distance threshold, the two pre-curated 3D point cloud clusters are merged into a same pre-curated 3D point cloud cluster.

In some non-limiting implementations, wherein the distance between two pre-curated 3D point cloud clusters is a color distance.

In some non-limiting implementations, identifying the object-of-interest is based on calculated cluster parameters. In this implementation a pre-curated 3D point cloud cluster having a highest cluster parameter is identified; and the other pre-curated 3D point cloud clusters are removed from the 3D point cloud.

In some non-limiting implementations, determining a cluster parameter comprises determining a resolution of the pre-curated 3D point cloud cluster by determining; for each data point of the pre-curated 3D point cloud cluster, a neighbor distance to a nearest neighbor data point within the pre-curated 3D point cloud cluster; and determining an average of the neighbor distances of the data points of the pre-curated 3D point cloud cluster.

In some non-limiting implementations, a statistical outlier removal process is applied prior to determining a corresponding cluster parameter for each of the 3D point cloud clusters.

In some non-limiting implementations, identifying a planar surface within the 3D point cloud comprises identifying a surface in the 3D point cloud that is perpendicular to a reference axis.

In some non-limiting implementations, prior to removing the first data point from the 3D point cloud: determining a main normal vector of the planar surface; and in response to an angular difference between a local normal vector at a given data point of the first data points and the main normal vector being above an angular threshold, excluding the given data points from the first data points.

In some non-limiting implementations, the planar surface is a ground planar surface.

In some non-limiting implementations, the cluster parameter is defined by:

$$\frac{n umber of points within cluster}{cluster mass center \times cluster resolution} .$$

In some non-limiting implementations, prior to identifying the first data points that define the planar surface, defining a search area within the 3D point cloud for searching the planar surface, wherein defining the search area comprises determining a bounding box of the 3D point cloud; and/or defining the search area as a portion of the bounding box.

In some non-limiting implementations, the search area is a lower portion of the bounding box.

In some non-limiting implementations, the search area comprises determining a bounding box of the 3D point cloud; determining a delimiting sphere having a center at a center of mass of the 3D point cloud, a radius of the delimiting sphere being determined based on a dimension of the bounding box; and/or defining the search area as an intersection of the bounding box and an exterior of the delimiting sphere.

In some non-limiting implementations, removing a pre-curated 3D point cloud cluster from the 3D point cloud is performed in response to a number of data points of the pre-curated 3D point cloud cluster being below a data point threshold.

In some non-limiting implementations, 3D point cloud is representative of at least a portion of a human body.

In some non-limiting implementations, there is provided a computer-implemented method for extracting an object-of-interest from a 3D point cloud prior to performing 3D operation onto the extracted object-of-interest, the 3D point cloud comprising a plurality of data points, the system comprising a controller and a memory storing a plurality of executable instructions which, when executed by the controller, cause the system to perform the method in accordance with the present technology.

In a second broad aspect of the present technology, there is provided a computer-implemented method for removing a planar surface from a 3D point cloud, the 3D point cloud comprising a plurality of data points. The method includes accessing the 3D point cloud, identifying a planar surface within the 3D point cloud, identifying first data points that define the planar surface from the 3D point cloud, identifying second data points for which a distance to the planar surface is below a first distance threshold, identifying third data points for which a color distance to the planar surface is below a second distance threshold and removing the first, second and third data points from the 3D point cloud to create pre-curated 3D point cloud clusters.

In some non-limiting implementations, identifying a planar surface within the 3D point cloud comprises identifying a surface in the 3D point cloud that is perpendicular to a reference axis.

In some non-limiting implementations, the method further includes, prior to removing the first, second and third data points from the 3D point cloud to create pre-curated 3D point cloud clusters, determining a main normal vector of the planar surface, in response to an angular difference between a local normal vector at a given data point of the first data points and the main normal vector being above an angular threshold, excluding the given data point from the first data points.

In some non-limiting implementations, the method further includes, prior to identifying the first data points, defining a search area within the 3D point cloud for searching the planar surface.

In some non-limiting implementations, defining the search area includes determining a bounding box of the 3D point cloud, and defining the search area as a portion of the bounding box.

In some non-limiting implementations, the search area is a lower portion of the bounding box.

In some non-limiting implementations, defining the search area includes determining a bounding box of the 3D point cloud, determining a delimiting sphere having a center at a center of mass of the 3D point cloud, a radius of the delimiting sphere being determined based on a dimension of the bounding box, and defining the search area as an intersection of the bounding box and an exterior of the delimiting sphere.

In a third broad aspect of the present technology, there is provided a computer-implemented method for identifying an object-of-interest from a 3D point cloud, the 3D point cloud comprising a plurality of data points. The method includes accessing the 3D point cloud, defining at least one cluster of data points, for each of the at least one cluster, determining a corresponding cluster parameter based on a number of data points of the cluster, a location of a center of mass of the cluster with respect to a reference point of the 3D point cloud, and a resolution of the cluster and identifying the object-of-interest based on the calculated cluster parameters.

In some non-limiting implementations, defining at least one cluster of data points includes defining a plurality of clusters and, in response to a distance between two clusters being below a third distance threshold, merging the two clusters into a same cluster.

In some non-limiting implementations, the distance between two clusters is a color distance.

In some non-limiting implementations, the at least one cluster includes a plurality of clusters, and identifying the object-of-interest based on the calculated cluster parameters includes identifying a cluster having a highest cluster parameter and removing the other clusters from the 3D point cloud.

In some non-limiting implementations, determining a corresponding cluster parameter comprises determining a resolution of the cluster by determining, for each data point of the cluster, a neighbor distance to a nearest neighbor data point within the cluster and determining an average of the neighbor distances of the data points of the cluster.

In some non-limiting implementations, the method further includes applying a statistical outlier removal process subsequently to defining the at least one cluster of data points.

In some non-limiting implementations, the cluster parameter is defined by:

$$\frac{n umber of points within cluster}{cluster mass center \times cluster resolution} .$$

In a fourth aspect of the present technology, there is provided a system comprising a controller and a memory storing a plurality of executable instructions which, when executed by the controller, cause the system to perform any of the methods recited therein.

In a fifth aspect of the present technology, there is provided a non-transitory computer-readable medium comprising computer-readable instructions that, upon being executed by a system, cause the system to perform any of the methods recited therein.

In the context of the present specification, unless expressly provided otherwise, a computer system may refer, but is not limited to, an “electronic device”, an “operation system”, a “system”, a “computer-based system”, a “controller unit”, a “monitoring device”, a “control device” and/or any combination thereof appropriate to the relevant task at hand.

In the context of the present specification, unless expressly provided otherwise, the expression “computer-readable medium” and “memory” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives. Still in the context of the present specification, “a” computer-readable medium and “the” computer-readable medium should not be construed as being the same computer-readable medium. To the contrary, and whenever appropriate, “a” computer-readable medium and “the” computer-readable medium may also be construed as a first computer-readable medium and a second computer-readable medium.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

Additional and/or alternative features, aspects, and advantages of implementations of the present technology will become apparent from the following description, the accompanying drawings, and the appended claims.

FIG. 1 depicts a representative computing environment for executing computer-implemented described in the present disclosure, in accordance with various implementations of the present technology.

FIG. 2 is a flow diagram of a computer implemented method for extracting an object-of-interest from a 3D point cloud prior to performing 3D operations onto the extracted object-of-interest in accordance with various implementations of the present technology.

FIG. 3 is a flow diagram of a computer implemented method for removing a planar surface from a 3D point cloud in accordance with various implementations of the present technology.

FIG. 4 is an illustrative example of the gravity axis of a point cloud, and a normal vector for a point, which is within a threshold angle of the gravity axis.

FIG. 5 is an illustrative example of the portions of the point cloud that are related to a gravity-oriented surface.

FIG. 6 is an illustrative example of the outliers to a gravity-oriented surface.

FIG. 7 is an illustrative example of a point cloud of an object-of-interest with the first gravity-oriented surface removed.

FIG. 8 is a flow diagram illustrating operations of a computer implemented-method for a Hue Saturation Value (HSV) color-based filtering process in accordance with various implementations of the present technology.

FIG. 9 is an illustrative example of outliers in a point cloud that have a hue that is within a predetermined threshold of the mean hue of the gravity-oriented surface.

FIG. 10 is an illustrative example of the results of using an HSV filter to remove gravity-oriented surface outliers from a point cloud.

FIG. 11 is an illustrative example of a point cloud with a corresponding bounding box.

FIG. 12 is an illustrative example of a search volume defined in the bounding box.

FIG. 13 is an illustrative example of a radius around a first point and a second point.

FIG. 14 is an illustrative example of the operation of statistical outlier removal performed on a point cloud.

FIG. 15 is a block diagram of a transformation matrix-based scale and orientation refinement process according to the disclosed technology;

FIG. 16 shows an example of a translation ratio distribution in accordance with the disclosed technology.

FIG. 17 shows an example of an alignment between world coordinate system image positions and estimated positions before and after application of an iterative corresponding points (ICP) algorithm in accordance with the disclosed technology.

FIG. 18 illustrates regions of a point cloud (shown in 2D for clarity) having low and high curvatures.

FIG. 19 is a block diagram of a first portion of geometric-based region growing in a point cloud, in which initial seed points are defined in accordance with some implementations of the present technology.

FIG. 20 illustrates selection of an initial seed point.

FIG. 21 is a block diagram of a second portion of the first segmentation process, continuing the geometric-based region growing of FIG. 19 with initial region growing in accordance with some implementations of the present technology.

FIG. 22 illustrates a neighborhood defined around a seed point.

FIG. 23 illustrates normal vectors for each of the points in a neighborhood.

FIG. 24 illustrates formation of a region including points from a neighborhood that meet a geometrical criterion.

FIG. 25 illustrates identification of additional seed points within a neighborhood.

FIG. 26 is a block diagram of a third portion of the first segmentation process, continuing the geometric-based region growing of FIGS. 7 and 9 with additional region growing.

FIG. 27 illustrates selection of a seed point that is already assigned to a region.

FIG. 28 illustrates selection of a seed point that is not already assigned to a region.

FIG. 29 illustrates an expanded region and a new region in accordance with some implementations of the present technology.

FIGS. 30 to 32 are flow charts showing operations of a method for performing a color-based region growing in a point cloud, in which initial seed points are defined in accordance with some implementations of the present technology.

FIG. 33 is a flow chart showing operations of a method for merging regions into clusters and a process for optimizing clusters through statistical color outlier filtering in accordance with some implementations of the present technology.

FIGS. 34 and 35 illustrate statistical outlier filtering to obtain optimized clusters in accordance with some implementations of the present technology.

FIGS. 36 and 37 illustrate statistical outlier filtering for fine outlier filtering.

FIG. 38 shows a raw 3D point cloud with colors.

FIG. 39 shows color-based outliers in the point cloud;

FIG. 40 shows a filtered point cloud after the removal of the outliers;

FIG. 41 is a flow diagram showing operations of a method for removing a planar surface from a 3D point cloud including a plurality of data point, in accordance with some non-limiting implementations of the present technology.

FIG. 42 is a flow diagram showing operations of a method for identifying an object-of-interest from a 3D point cloud including a plurality of data points in accordance with some non-limiting implementations of the present technology.

It is to be understood that throughout the appended drawings and corresponding descriptions, like features are identified by like reference characters. Furthermore, it is also to be understood that the drawings and ensuing descriptions are intended for illustrative purposes only and that such disclosures are not intended to limit the scope of the claims.

### DETAILED DESCRIPTION

Various implementations of the described technology will be described more fully hereinafter with reference to the accompanying drawings. The present technology may, however, be embodied in many different forms and should not be construed as limited to the implementations set forth herein. Rather, these implementations are provided so that the disclosure will be thorough and complete, and will fully convey the scope of the disclosed technology to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is only intended to describe particular implementations and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams, flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some implementations of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

In the context of the present technology, a “3D point cloud” may refer to a simple 3D representation of an object-of-interest where the vertices are not necessarily connected to each other. If they are not connected to each other, the basic information contained in this kind of representation are the coordinates (e.g., x, y, z) within a Cartesian coordinate system of each vertex. Other information may be contained, such as vertices color (e.g., r, g, b) within an RGB color space. A 3D point cloud is the simplest representation of a 3D object-of-interest and the present implementations are compatible with 3D point clouds. The 3D point cloud is often used as the result of a 3D scanning and a very common format for those files is the Polygon File Format (PLY).

With these fundamentals in place, we will now consider some non-limiting examples to illustrate various implementations of aspects of the present technology.

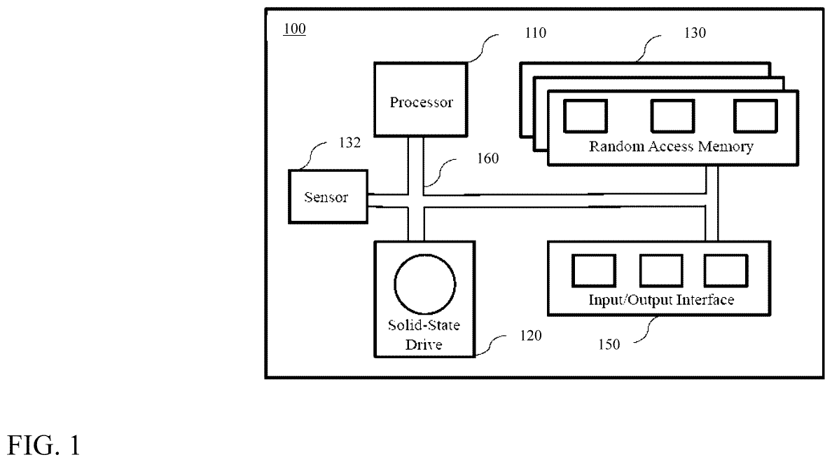

FIG. 1 illustrates a diagram of a computing environment 100 in accordance with an implementation of the present technology is shown. In some implementations, the computing environment 100 may be implemented by any of a conventional personal computer, a computer dedicated to operating generation of 3D representation of objects, a remote server and/or an electronic device (such as, but not limited to, a mobile device, a tablet device, a server, a controller unit, a control device, a monitoring device etc.) and/or any combination thereof appropriate to the relevant task at hand. In some implementations, the computing environment 100 comprises various hardware components including one or more single or multi-core processors collectively represented by a processor 110, a solid-state drive 120, a random access memory 130, one or more sensors 132 and an input/output interface 150. The computing environment 100 may be a computer specifically designed for operating generation of 3D representation of objects. In some alternative implementations, the computing environment 100 may be a generic computer system.

In some implementations, the computing environment 100 may also be a sub-system of one of the above-listed systems. In some other implementations, the computing environment 100 may be an “off the shelf” generic computer system. In some implementations, the computing environment 100 may also be distributed among multiple systems. In some implementations, the computing environment 100 is virtualized in the “cloud” so that processing power and/or memory capacity may be scaled up or down depending on actual needs for executing implementations of the present technology. The computing environment 100 may also be specifically dedicated to the implementation of the present technology. As a person in the art of the present technology may appreciate, multiple variations as to how the computing environment 100 is implemented may be envisioned without departing from the scope of the present technology.

Communication between the various components of the computing environment 100 may be enabled by one or more internal and/or external buses 160 (e.g. a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wire or wireless access. As an example, the input/output interface 150 may include a networking interface such as, but not limited to, a network port, a network socket, a network interface controller and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network, allowing communication among small groups of computers on the same local area network (LAN) and large-scale network communications through routable protocols, such as Internet Protocol (IP).

According to implementations of the present technology, the solid-state drive 120 stores program instructions suitable for being loaded into the random access memory 130 and executed by the processor 110 for executing generation of 3D representation of objects. For example, the program instructions may be part of a library or an application.

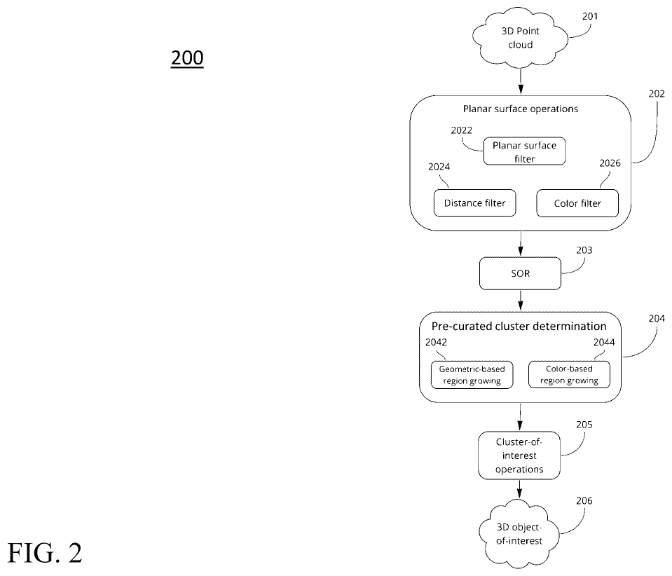

FIG. 2 depicts a high-level flow diagram of computer-implemented method 200 of a method of obtaining an object-of-interest from a 3D point cloud, in accordance with the implementations of the present disclosure. The method 200 is directed to obtain at least one object-of-interest indicative of a desired object. It is to be expressly understood that the method 200 as depicted are merely an illustrative implementation of the present technology. In some cases, what are believed to be helpful examples of modifications to the method 200 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the device 10 may provide in certain instances simple implementations of the present technology, and that where such is the case they have been presented in this manner as an aid to understanding. As persons skilled in the art would understand, various implementations of the present technology may be of a greater complexity.

It will be understood that the method 200 or one or more steps thereof may be performed by a computer system, such as the computer system 100. The method 200, or one or more steps thereof, may be embodied in computer-executable instructions that are stored in a computer-readable medium, such as a non-transitory mass storage device, loaded into memory and executed by a CPU. Some steps or portions of steps in the flow diagram may be omitted or changed in order.

In use and as will be described in greater details herein after, the computer system 100 may execute a planar surface operations module to remove data points associated to the at least one ground planar surface and/or to obtain the at least one pre-curated 3D point cloud cluster. The computer system 100 may further execute a statistical outlier removal (SOR) module to further refine the at least one pre-curated 3D point cloud cluster, a segmentation module to obtain the at least one cluster-of-interest, and a cluster-of-interest operation module to identify the at least one 3D object-of-interest. Execution of said modules is performed by executing the method 200 for extracting an object-of-interest from a 3D point cloud prior to performing 3D operations onto the extracted object-of-interest, operations of which being depicted under the form of a flow diagram on FIG. 2.

The method 202 includes accessing, at operation 202, a raw 3D point cloud. The 3D point cloud may be acquired or may have been previously acquired and is accessed from a memory or storage device upon executing the method of the present technology. As used herein, a point cloud, or 3D point cloud reconstruction, may refer to a simple 3D representation of an object where the vertices are not necessarily connected to each other. If they are not connected to each other, the information contained in this kind of representation is the coordinates (e.g., x, y, z in the case of a cartesian coordinate system) of each vertex, and/or its color (e.g., components in the Red-Green-Blue color space). The 3D point cloud reconstruction may be the result of 3D scanning, and a common format for storing such point clouds is the Polygon File Format (PLY). Point cloud reconstructions are seldom used directly by users, as they typically do not provide a realistic representation of an object, but rather a set of 3D points without relations to each other aside from their positions and colors.

In some implementations, acquiring a 3D point cloud may involve using a plurality of depth maps, each depth map corresponding to an image within a stream of images acquired using, e.g., the sensor 132 as shown in FIG. 1. Generating each depth map may include executing a machine learning algorithm (MLA), which may include a deep learning algorithm (DLA), based on the image and a second image of the stream of images. In some implementations, generating each depth map may include utilizing depth information provided by one or more depth sensor(s) integrated within the imaging system. In some implementations, generating each depth map may include utilizing at least two images at the same position and coordinates, within the imaging system's coordinate system, using at least two lenses (e.g., using a dual or triple lens Red-Green-Blue (RGB) imaging system).

In some implementations, a plurality of fragments of an object's 3D point cloud can be generated based on depth map information. Each fragment may be a 3D point cloud generated based on at least one image, the corresponding depth maps of the at least one image, and the corresponding positions of the imaging system of the at least one image. These fragments can be merged to form a single 3D point cloud.

In some implementations, operation 202 includes both macro removal of a planar surface beneath and/or adjacent to an object or on which an object is resting, as well as operations employing color filtering (by any color space know by the skilled person) to remove the points with similar color values and normal direction to the planar surface that has been removed. It will be understood by those of ordinary skill in the art that, although illustrative examples of execution of the operation 202 are described as removing gravity-oriented surfaces, the same techniques could be used, mutatis mutandis, to remove planar surfaces oriented in other directions, perpendicular to a reference axis. The use of “gravity-oriented” surfaces, and a “gravity axis” are, therefore, merely for illustration.

In some implementations, operation 202 may include execution of a planar surface module 2022, a distance filter module 2024 and/or a color filter module 2026.

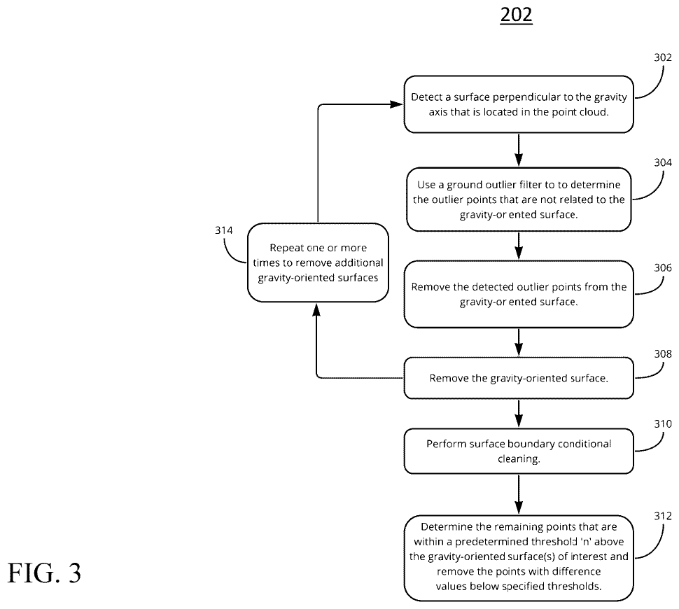

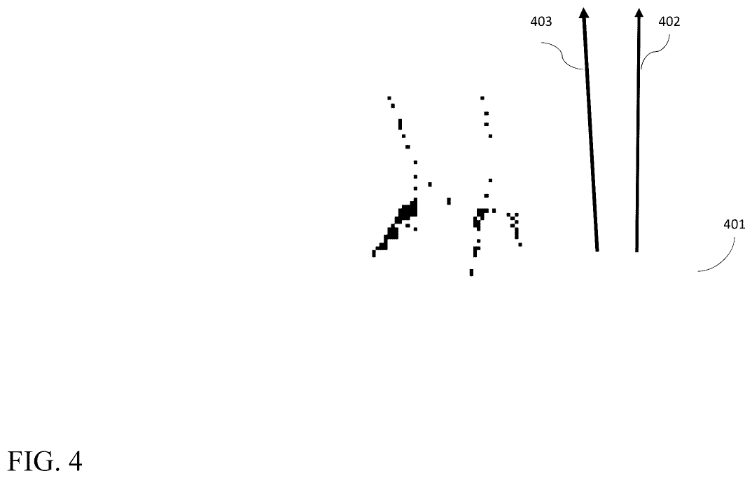

An illustrative example of the execution of operation 202 is depicted in FIG. 3 in accordance with some non-limiting implementations of the present technology. At sub-operation 302, a surface perpendicular to the gravity axis is detected. The gravity axis is an axis that is oriented along the direction of gravity. In some implementations, the surface perpendicular to the gravity axis may be detected by finding points that have a normal vector that is within a predetermined threshold angle of the gravity axis. In some implementations, this threshold angle may be, e.g., 0.5 radians. This is illustrated in FIG. 4, which shows a reference axis 402 (e.g. a gravity axis) associated with a 3D point cloud 401, and a normal vector 403 for a point, which is within a threshold angle of the reference axis 402 (e.g. a gravity axis in this example), indicating that the point may be on a surface perpendicular to the gravity axis. Again, the gravity axis is a mere example of a reference axis that is used for operations to improve the quality of a point cloud described herein. Any other reference axis may be used.

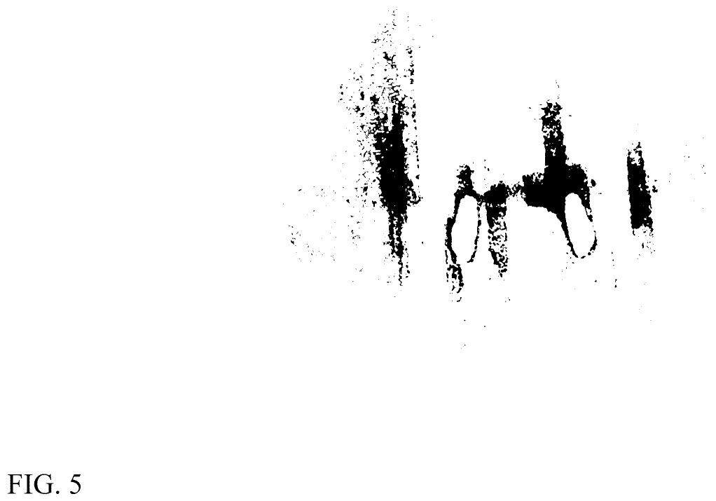

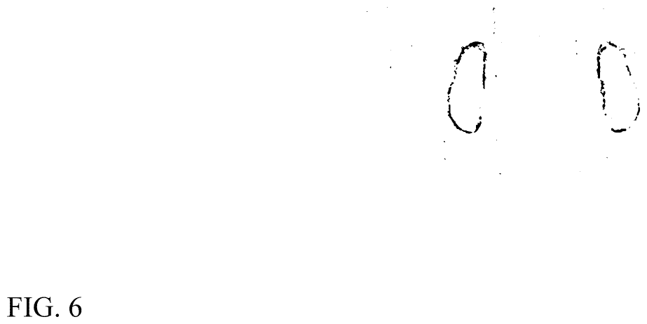

Continuing with FIG. 3, a ground outlier filter is employed at sub-operation 304 on the detected gravity-oriented surface to determine the outlier points that are not related to the gravity-oriented surface. Points with normal vectors having an orientation that does not correspond to the surface normal orientation are considered to be outliers to the gravity-oriented surface. These detected outlier points may be inliers related to an object-of-interest, or they may be points within the ground-oriented surface with non-perpendicular normals, which will generally be removed by a statistical outlier removal process. This is illustrated in FIGS. 5-6. In FIG. 5, the portions of the point cloud that are related to the gravity-oriented surface are shown, while FIG. 6 depicts the outliers to the gravity-oriented surface, which will be kept in the point cloud after the gravity-oriented surface is removed.

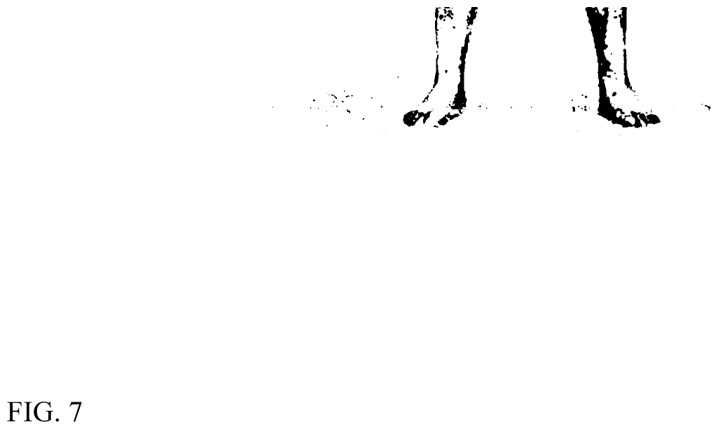

Referring to FIG. 3, the detected outlier points are removed from the detected gravity-oriented surface at sub-operation 306. At sub-operation 308, the gravity-oriented surface is removed (i.e., points in the point cloud that have been determined above to be part of the gravity-oriented surface are removed). This is depicted in FIG. 7, which shows the point cloud with the first gravity-oriented surface removed. It will be noted that noise related to the outlier points remains in the point cloud.

Referring to FIG. 3, in some implementations the gravity-oriented surface could be a combination of two (or more) surfaces. Accordingly, sub-operations 302, 304, 306, and 308 may be repeated 314 one or more times to detect a second (or further) gravity-oriented surface in the same region with a similar orientation to the first detected gravity-oriented surface. Again, the gravity-oriented surfaces described here are only mere examples of planar surfaces that may be removed by the processes described herein. Any planar surface may be removed in a similar manner.

At sub-operation 310, surface boundary conditional cleaning may be performed. This may be done, e.g., by identifying points that are located beneath the at least one gravity-oriented surface-of-interest and removing them. In a more general aspect, the object of interest is located on a first side of the at least one gravity-oriented surface (i.e. facing a first side thereof), and performing the surface boundary conditional cleaning comprises removing points that are located on a second side of the at least one gravity-oriented surface.

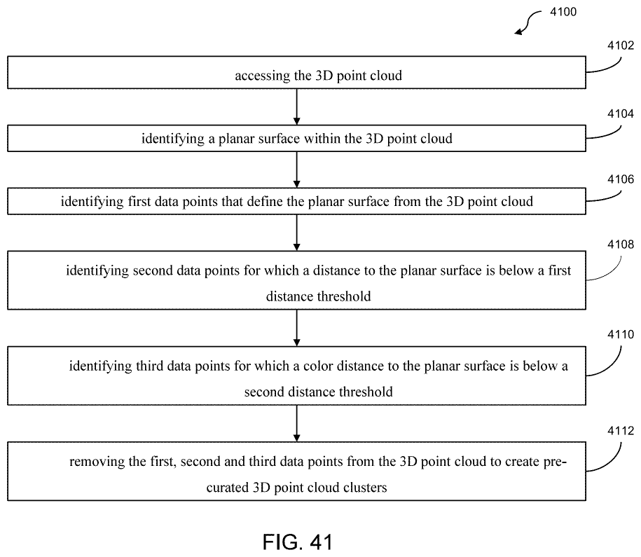

In some implementations, execution of the operation 202 may further include execution of method 4100 or a portion thereof. With reference to FIG. 41, there is depicted a flow diagram of operations of the method 4100 for removing a planar surface from a 3D point cloud in accordance with some implementations of the present technology, the 3D point cloud comprising a plurality of data points.

The method 4100 includes accessing at operation 4102, a 3D point cloud such as 3D point cloud 401.

The method 4100 further includes identifying, at operation 4104, a planar surface within the 3D point cloud. In some implementations, identifying a planar surface within the 3D point cloud includes identifying a surface in the 3D point cloud that is perpendicular to a reference axis, such as the reference axis 402.

The method 4100 further includes identifying, at operation 4106, first data points that define the planar surface from the 3D point cloud.

The method 4100 further includes identifying, at operation 4108, second data points for which a distance to the planar surface is below a first distance threshold.

The method 4100 further includes identifying, at operation 4110, third data points for which a color distance (e.g. HSV distance) to the planar surface is below a second distance threshold.

The method 4100 further includes removing, at operation 4112, the first, second and third data points from the 3D point cloud to create pre-curated 3D point cloud clusters. Any known suitable clustering process may be applied at this operation to obtain the pre-curated 3D point cloud clusters upon removal of the first, second and third data points from the 3D point cloud.

In some implementations, the method 4100 further includes, prior to removing the first, second and third data points from the 3D point cloud to create pre-curated 3D point cloud clusters, determining a main normal vector of the planar surface, in response to an angular difference between a local normal vector at a given data point of the first data points and the main normal vector being above an angular threshold, excluding the given data points from the first data points.

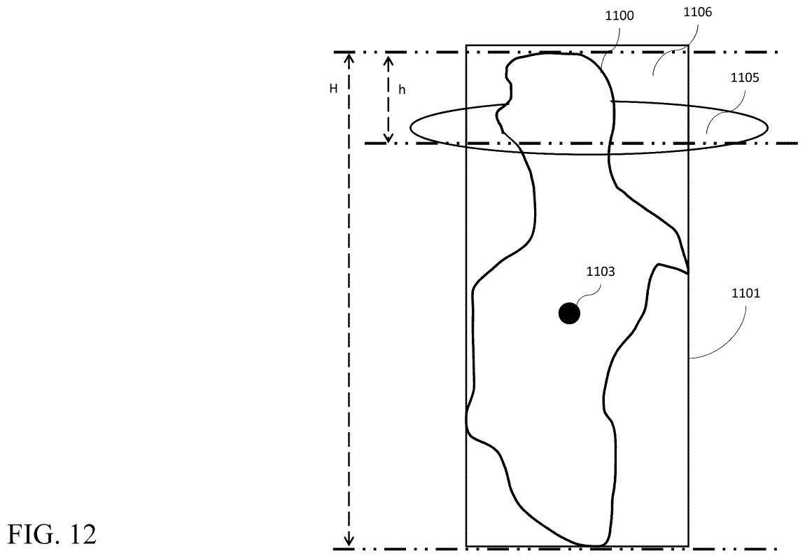

In some implementations, the method 4100 further includes, prior to identifying the first data points, defining a search area within the 3D point cloud for searching the planar surface. For example and without limitation, defining the search area may include determining a bounding box of the 3D point cloud and defining the search acra as a portion of the bounding box. The search area may a lower portion of the bounding box. This will be described in greater details hereinafter with reference to FIG. 12.

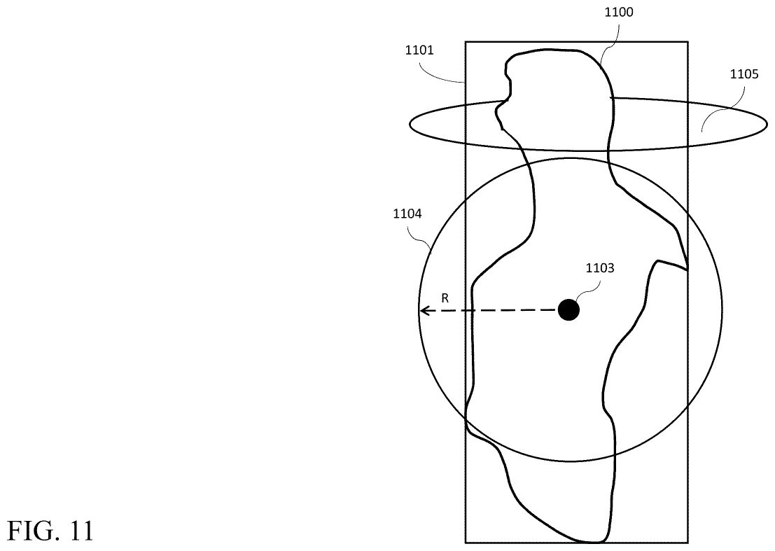

In some other implementations, defining the search area may include determining a bounding box of the 3D point cloud, determining a delimiting sphere having a center at a center of mass of the 3D point cloud, a radius of the delimiting sphere being determined based on a dimension of the bounding box and defining the search area as an intersection of the bounding box and an exterior of the delimiting sphere. This will be described in greater details hereinafter with reference to FIG. 11.

Referring back to FIG. 3, the remaining points that are within a predetermined threshold ‘n’ above the at least one gravity-oriented surface-of-interest are identified at sub-operation 312. In some implementations, this threshold ‘n’ may be related to the size of the 3D reconstruction and may be, e.g., a specified percentage of a dimension of a bounding box, such as 1% of the height of the bounding box. In some implementations, the threshold ‘n’ may be set to a constant value, such as 2 cm.

The colors and normals of points that are within the predetermined threshold ‘n’ above the at least one gravity-oriented surface-of-interest are determined, and thresholds are used to determine if the points are part of the at least one gravity-oriented surface-of-interest. For example, in some implementations, the threshold for the normal may be 0.90 radians between the normal of the point and the mean normal of the at least one gravity-oriented surface-of-interest. In some implementations, the color threshold may be a value difference of 70 (assuming 8-bit color channels-so 70 out of a range of 0-255 for each color channel) between the R, G, and B color channels (assuming that an RGB color space is being used) and the mean color of the gravity-oriented surface-of-interest. It will be understood that other values could be used in various implementations, depending on the color space and the range of values for each color in the color space. In a broad aspect, the present technology may be suitable for minimizing inadvertent removal of points on the object-of-interest.

In some implementations, the at least one color and normals of points that are within a predetermined threshold ‘n’ above the at least one gravity-oriented surface-of-interest are determined, and thresholds are used to determine whether or not the points are part of the at least one gravity-oriented surface.

In the same or other implementations, Hue Saturation Value (HSV) color-based operations may be performed for the removal of points. While the process is described below for an HSV color space, it will be understood that an RGB color space, or any other color space known in the art could be used. The developers of the present technology have realized that, in this implementation, the use of the HSV color space may provide benefits for removing noise. Indeed, in the HSV color space, color information is comprised in one channel whereas the same information is distributed in the three channels of the RGB color space. As a result, use of the HSV color space may provide faster computation time and higher precision for removing delocalized noise. It should also be noted that the developers of the present technology have realized that, in this implementation, the use of the RGB color space may provide benefits for removing localized noise. As such, conversion of the information from the HSV color space to the RGB color space, or from the RGB color space to the HSV color space, may be performed between subsequent operations of any method or process described herein.

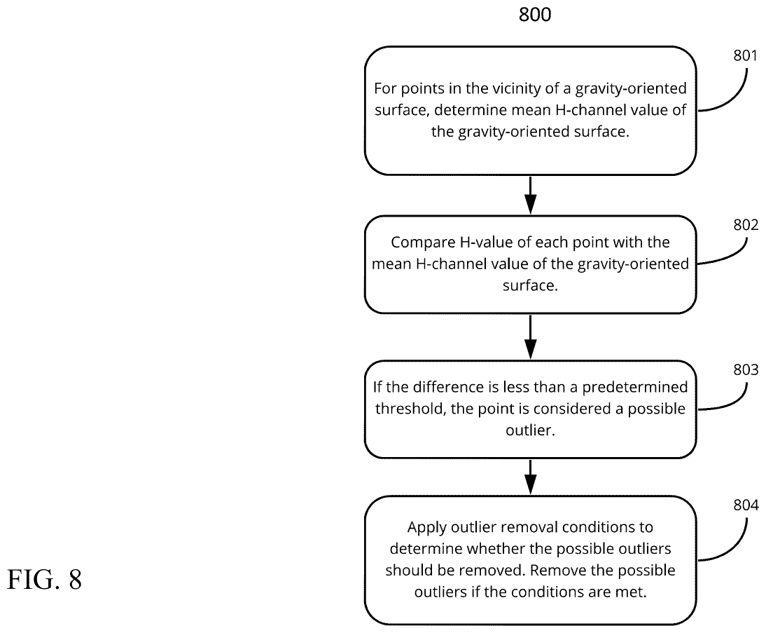

Referring to FIG. 8, a flow diagram of a method 800 for performing an HSV color-based filtering process for removing points from a gravity-oriented surface in accordance with non-limiting implementations of the present technology is depicted. In some implementations, execution of the sub-operation may include execution of the method 800. The method 800 may be used, for example, in areas of strong curvature that are in the proximity of a gravity-oriented surface.

The method 800 includes determining, at operation 801, the mean H-channel (hue channel) value of the gravity-oriented surface.

The method 800 includes comparing, at operation 802, for points in the vicinity of a gravity-oriented surface, the H-value of a point with the mean H-channel value of the gravity-oriented surface.

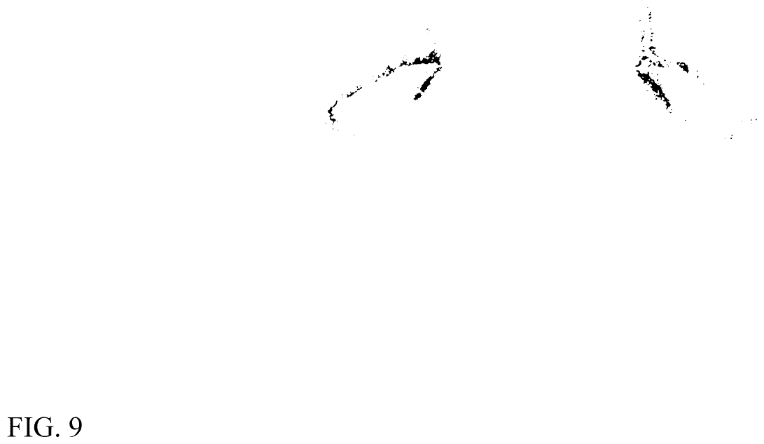

The method 800 includes identifying, at operation 803, the point as a possible outlier to the point cloud in response to the H-channel value difference being less than a predetermined threshold (i.e., if its hue is close to the mean hue of the gravity-oriented surface, then the point may actually be part of the gravity-oriented surface, rather than an object-of-interest in the point cloud). In some implementations where the H-channel is coded on 8 bits (i.e., it has a value of 0-255), the threshold may be 5. This is illustrated in FIG. 9, which shows the possible outliers in the point cloud that have a hue that is within a predetermined threshold of the mean hue of the gravity-oriented surface.

Further referring to FIG. 8, the method 800 includes applying, at operation 804, outlier removal conditions to determine whether the possible outliers should be removed, and the possible outliers are removed if the conditions are met. In some implementations, there may be multiple outlier removal conditions. For example, in some implementations, according to a first condition, the color-based filtering is not applied (i.e., the possible outliers are not removed) if the number of points that are considered possible outliers in a specified region of the point cloud exceeds a predetermined threshold. For example, in some implementations, if more than 5% of the points in a defined region (such as a rectangle region centered in the middle of the point cloud) of a defined size (e.g., 30 cm in height, in the case of a human body) are considered possible outliers, then the color-based filtering is not applied. According to a second condition, the color-based filtering is not applied if the number of points that are considered possible outliers in the entire point cloud exceeds a predetermined threshold. For example, in some implementations, if more than 25% of the points in the entire point cloud are possible outliers, the color-based filtering is not applied. If the thresholds of both the first condition and the second condition are not reached, then the possible outliers are removed from the point cloud.

In some implementations, a single condition may be sufficient. For example, in some RGB-based implementations, if more than 3% of the points in the point cloud are possible outliers, then the color-based filtering is not applied.

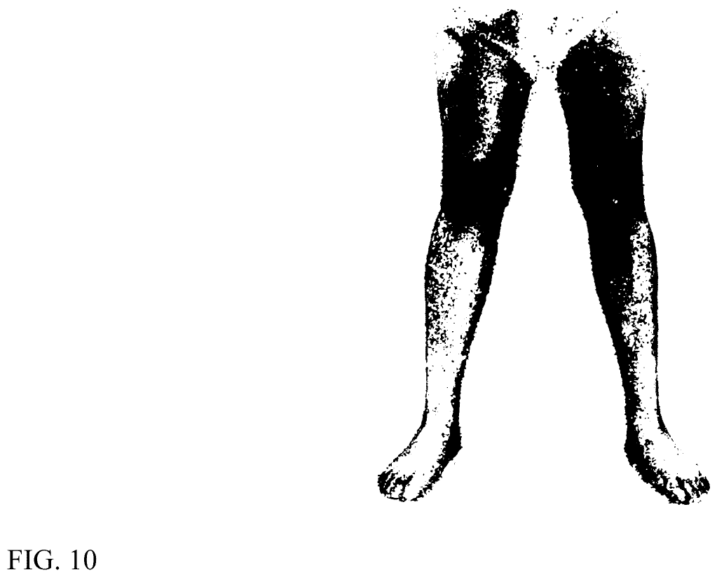

FIG. 10 depicts the results of using the above-described HSV filtering to remove gravity-oriented surface outliers illustrated in FIG. 9.

It will be understood that some implementations may use other processes for removing points from a gravity-oriented surface. For example, in some RGB color space-based implementations, a series of four conditions may be used. According to a first condition (a red channel analysis), the difference between the red channel of a point and the average red channel value for all gravity-oriented surface points is calculated. If the calculated value is below a predetermined threshold P, the corresponding point is considered a possible outlier. According to a second condition (red and green channel analysis), the ratio between the red and green channels of a point is compared to the ratio between the mean red and green channels for all the gravity-oriented surface points. If the calculated value is below a predetermined threshold Q, the corresponding point is considered a possible outlier. According to a third condition (green and blue channel analysis), the ratio between the green and blue channels of a point is compared to the ratio between the mean green and blue channels for all the gravity-oriented surface points. If the calculated value is below a predetermined threshold R, the corresponding point is considered a possible outlier. According to a fourth condition (blue and red channel analysis) the ratio between the blue and red channels of a point is compared to the ratio between the mean blue and red channels for all the gravity-oriented surface points. If the calculated value is below a predetermined threshold S, the corresponding point is considered a possible outlier. If all these conditions are met, then the corresponding point is an outlier, and may be removed from the point cloud.

In a more general aspect and with reference to FIG. 11, there is described another process for locating planar surfaces to be removed according to some implementations of the present technology. More specifically, FIG. 11 shows a point cloud 1100 with a corresponding bounding box 1101. For clarity purposes, the point cloud is depicted as a shape 1100 corresponding to contours of the point cloud, the shape 1100 being a 3D shape surrounding all the points of the point cloud (e.g. a concave-hull of the point cloud). The bounding box 1101 may be generated by any known suitable computer vision algorithms and techniques. In this implementation, a mass center 1103 of the point cloud is determined based on coordinates of points thereof. A delimiting sphere 1104 centered on the mass center 1103 is further determined. In the illustrative example of FIG. 11, a radius ‘R’ of the delimiting sphere 1104 is 0.7 times a minimal dimension of the bounding box 1101 (e.g. a width thereof). Other ratios between the radius of the delimiting sphere 1104 and dimensions of the bounding box 1101 are contemplated in alternative implementations. Planar surfaces may further be searched outside the delimiting sphere 1104 and in the bounding box 1101. It can be said that the delimiting sphere 1104 defines a volume for searching the planar surfaces to be removed, said volume being defined on an exterior side of the delimiting sphere 1104.

For example, a planar surface 1105, which is a gravity-oriented surface in this example, intersect the bounding box 1101 and is on an exterior side of the delimiting sphere 1104. As such, the planar surface 1105 may be removed according to techniques disclosed herein. It can be said that, by determining the delimiting sphere 1104 from the mass center 1103, the planar surfaces to be removed are searched at or close to extremities of the point cloud.

Alternatively, the radius of the delimiting sphere is determined based on a maximal dimension (e.g. a height in the example of FIG. 11) of the bounding box 1101 or any other dimension thereof. For example, the radius of the delimiting sphere 1104 may be 0.7 times a maximal dimension of the bounding box 1101 (e.g. a height thereof).

In some alternative implementations and with reference to FIG. 12, a search volume 1106 may be defined in the bounding box 1101. A higher dimension of the bounding box 1101 is determined. In the example of FIG. 12, said higher dimension is a height H of the bounding box 1101. The search volume 1106 is defined at a first end of the bounding box 1101 along said higher dimension. A size h of the search volume along said higher dimension is, in this implementation, 0.3 times the height H such that h=0.3H. Other ratio between the size h and the size H of the higher dimension are contemplated in alternative implementations. Another search volume may be defined at another end of the bounding box along the higher dimension. The same process may be applied to other dimensions (e.g. second higher dimension) of the bounding box to defined other search volumes. In this implementation, planar surfaces to be removed are further searched in the search volume 1106.

For example, the planar surface 1105, which is a gravity-oriented surface in this example, is located withing the search volume 1106. As such, the planar surface 1105 may be removed according to techniques disclosed herein. It can be said that, by determining the search volume 1106 at an end of the bounding box 1101 as described hereabove, the planar surfaces to be removed are searched at or close to extremities of the point cloud.

In some implementations, execution of the operation 202 of method 200 may include execution of the distance filter module 2024 and/or the color filter module 2026.

It should be noted that in the examples shown below, an RGB color space is described, but it will be understood that this is only for illustration. In some implementations, color outlier filtering may use an RGB color space. In some implementations, an HSV color space, or any other color space known to those of skill in the art may be used.

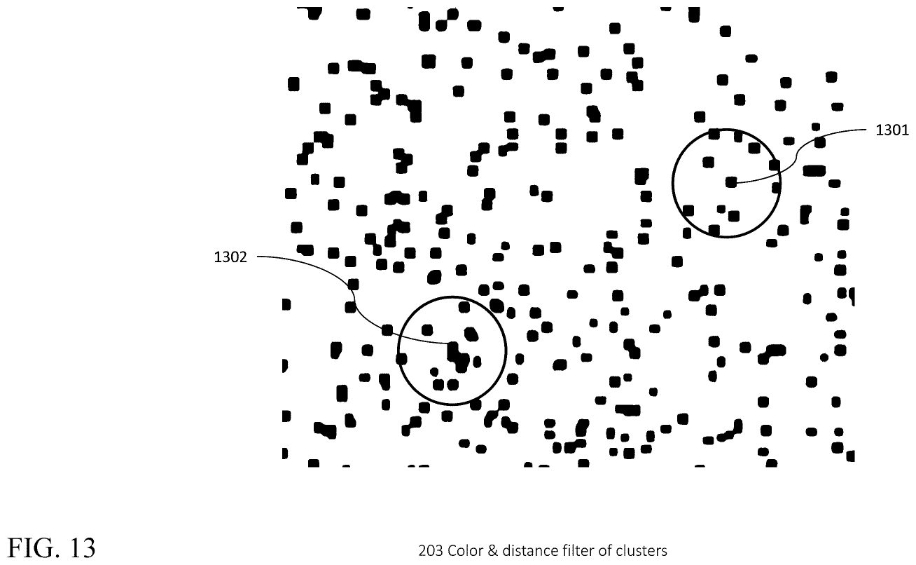

In some implementations of the distance filter module 2024, the mean and standard deviation of each color channel is calculated for each point in the point cloud and the at least one neighbor within a defined threshold. The points for which the means and standard deviations are calculated are referred to as a “nearest neighbor region”. In some implementations, the number of neighbors may be, for example, 4*K neighbors, where K is the mean number of points inside the volume of a defined radius. In some implementations, this defined radius may be a multiple of the resolution, such as 5*Resolution. This is illustrated in FIG. 13, which shows (as 2D circles, for clarity) the 5*Resolution radius around a first point 1301 and a second point 1302, and K would be calculated as the mean number of points within this radius.

In some implementations of color filter module 2026, a point may be considered an outlier if the at least one color channel has a value that exceeds a predefined multiple of the standard deviation from the mean of the nearest neighbor region for the specified color channel. For example, in some implementations, if the difference between the R, G or B color and the mean value of the nearest neighbor region of the specified point is greater than twice the standard deviation of the nearest neighbor region, the point is considered as an outlier. In some implementations, such outlier points may be removed.

In some implementations of the method 200, execution of the distance filter module 2024 and/or filter module 2026 may precede execution of the ground planar operations module 2022.

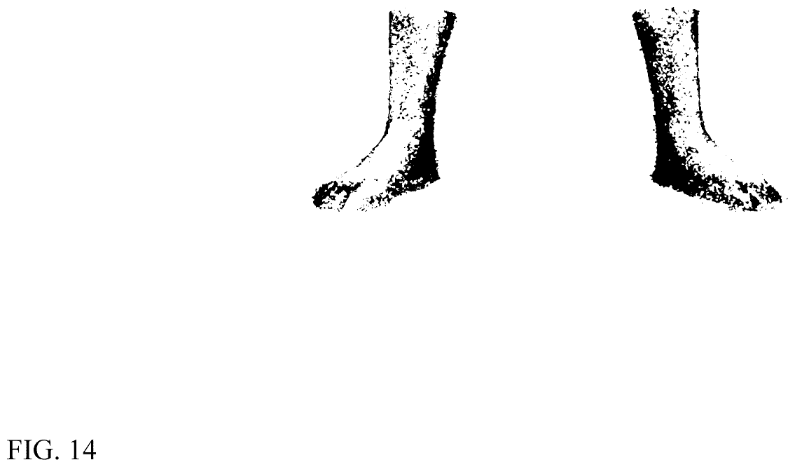

Referring back to FIG. 2, the method 200 includes preforming a statistical outlier removal operation 203 to improve a quality of the 3D point cloud accessed at operation 201. FIG. 14 is an illustrative example of the operation of statistical outlier removal performed on the image of FIG. 10.

In some implementations, such outlier points are determined during the statistical outlier removal operation 203 based on a threshold. Said threshold may be determined based on a predetermined factor M and on the standard deviation of the K closest neighbor distances between the points in the point cloud (where K is a predetermined integer). This standard deviation may be determined by calculating the closest neighbor distance for each point in the point cloud and performing a statistical analysis to obtain the mean and standard deviation of the K closest neighbor distances between the points. Outliers may be considered to be points that are more distant from their neighbors than M standard deviations from the mean of the distribution of distances of the K closest neighbors. Thus, the higher the value of M, the less aggressive the removal of outliers. In some implementations, the value of M may be 1. It should be noted that there is no relationship assumed between ground or the object in the statistical outlier removal.

While a particular process for statistical outlier removal is discussed above, it will be recognized that other methods for statistical outlier removal may be used.

The method 200 further includes execution of a pre-curated cluster determining module at operation 204 to obtain the pre-curated clusters. In some implementations of the method 200, execution of the pre-curated cluster determining module may include execution of a geometric-based region growing operation 2042, and/or a color-based region growing operation 2044. The at least one operation of geometric-based region growing 2042 may include any method known to those skilled in the art. The at least one operation of color-based region growing 2044 may include any color space known to those skilled in the art. In some implementations, color-based region growing may use an RGB color space. In some implementations, an HSV color space, or any other color space known to those of skill in the art may be used.

In the context of the present disclosure, it is said that “pre-curated” clusters are formed from a 3D point cloud once the 3D point cloud has been clustered and one or more clusters have been defined therefrom. The clusters may have been denoised and/or having been associated with an identifier. For example, for a 3D point cloud representing two feet, two pre-curated clusters may be defined therefrom where each pre-curated cluster correspond to a given foot.

The method 200 further includes execution of a cluster-of-interest operations module at operation 205. A cluster parameter is calculated by the cluster-of-interest operations module for each pre-curated cluster. In some implementations, the cluster parameter is defined as:

$$\frac{n umber of points}{c l uster mass center \times resolution}$$

The cluster mass center is referenced to the “world origin,” which corresponds to a first camera position. In particular, the cluster mass center is the distance to the world origin. It should be noted that in some implementations, all processes are referenced to the world origin. The point cloud resolution (or simply “resolution”) may be calculated by obtaining a closest neighbor distance for each point in the point cloud, and calculating the average of the closest neighbor distances. The resolution is this closest neighbor distance average.

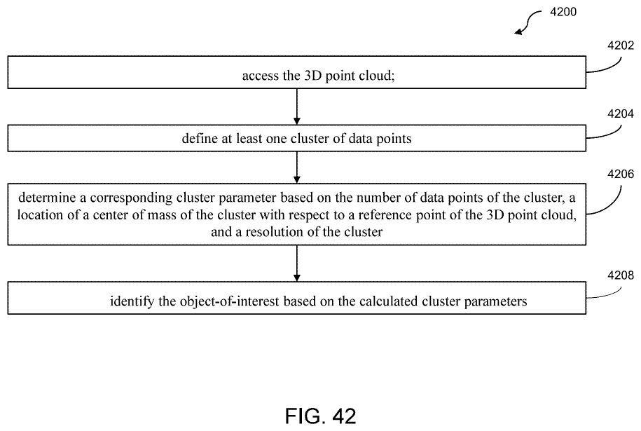

In some implementations, execution of the operation 206 may include execution of a computer-implemented method 4200, or a portion thereof, for identifying an object-of-interest from a 3D point cloud including a plurality of data points. FIG. 42 is a flow diagram showing operations of the method 4200 for identifying an object-of-interest from a 3D point cloud including a plurality of data points in accordance with some non-limiting implementations of the present technology.

The method 4200 includes accessing, at operation 4202, accessing a 3D points cloud.

The method 4200 further includes defining, at operation 4204, at least one cluster of data points. In some implementations, defining at least one cluster of data points may include defining a plurality of clusters and in response to a distance between two clusters being below a third distance threshold, merging the two clusters into a same cluster. For example, said distance between two clusters may be a color distance or a geometric distance. In some implementations, the method 4200 further includes applying a statistical outlier removal process subsequently to defining the at least one cluster of data points.

The method 4200 further includes determining, at operation 4206 and for each of the at least one cluster, a corresponding cluster parameter based on the number of data points of the cluster, a location of a center of mass of the cluster with respect to a reference point of the 3D point cloud, and a resolution of the cluster. In some implementations, determining a corresponding cluster parameter includes determining a resolution of the cluster by determining, for each data point of the cluster, a neighbor distance to a nearest neighbor data point within the cluster and determining an average of the neighbor distances of the data points of the cluster. For example and without limitation, the cluster parameter may be defined by:

$$\frac{n umber of points within cluster}{cluster mass center \times cluster resolution} .$$

The method 4200 further includes identifying, at operation 4208, the object-of-interest based on the calculated cluster parameters.

In some implementations, the at least one cluster includes a plurality of clusters. The method 4200 may further include extracting a cluster having a highest cluster parameter among the at least one cluster by identifying a cluster having a highest cluster parameter and removing the other clusters from the 3D point cloud.

In some implementations of the method 200, the point cloud is realigned with the gravity axis. The original orientation of the point cloud is known from the first detected gravity-oriented surface normal. The realignment of the point cloud may be performed using a transformation matrix defined by the original surface normal and the gravity axis. The realignment of the point cloud may be performed subsequent to any step contained within the method 200.

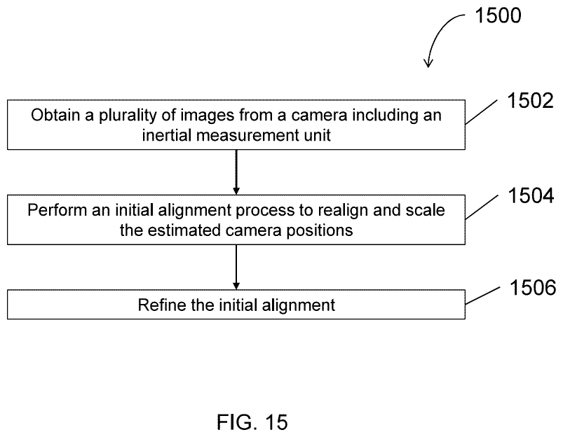

In some implementations of the method 200, a the method 1500 of the transformation matrix-based scale and orientation refinement process is depicted in FIG. 15.

In some implementations, at operation 1502, a plurality of images (a-n) are obtained from a camera including an inertial measurement unit. The plurality of images exists within a world coordinate system, based on the actual position and orientation of the camera during the capture. In some implementations, camera poses may be obtained from augmented reality processes based on (but not limited to) position/orientation sensors (e.g., accelerometers, gyroscopes, and the like) and used in known augmented reality libraries such as (but not limited to) ARKit™ from APPLE™ or ARCore™ from GOOGLE™. From the plurality of images (a-n), camera calibrations, intrinsic parameters and extrinsic parameters may be determined using known computer vision algorithms and techniques, such as known Structure-from-Motion (SfM) techniques. It should be noted that both world and estimated images of points a and b have the same indexing.

In some implementations, at operation 1504, an initial alignment process is performed to realign and scale the estimated camera positions of the image central camera positions in the world coordinate system (position and orientation) using a known RANdom Sampling Consensus (RANSAC) method.

In some implementations, at operation 1506, the initial alignment is refined. In some implementations, this may be done using a non-scaling iterative corresponding points (ICP) method. This is done by obtaining a plurality of world coordinate system image pairs, each such image pair including a defined first image (a) and a randomly selected second image (d). A distance is measured between the first image and the second image of the world coordinate system image pairs. Estimated position image pairs are obtained that correspond to the world coordinate system image pairs, and the distance is measured between the corresponding estimated image pairs, ax and dr.

In some implementations, m pairs are used per camera. The m different pairs are randomly generated for each camera position in a world coordinate system. In some such implementations, m can be based on the total number of obtained images n minus 1 (to exclude the current image)—i.e., m=(n*(n−1))/2. In some other implementations, m can be any value between 1 and (n*(n−1))/2. In some implementations, six pairs may be used per camera, and six different pairs may be randomly generated for each camera position in a world coordinate system.

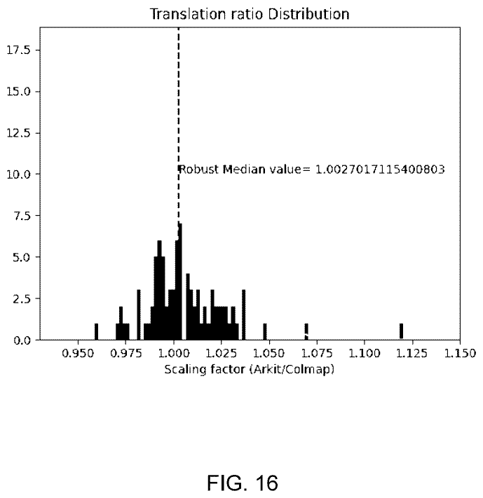

In some implementations, refining the initial alignment further involves obtaining a translation ratio distribution. This may be done by calculating the ratio between each world coordinate system pair distance and each estimated position pair distance—i.e., (world coordinate system distance) a-d/(estimated position distance)_{ax-dx}. Each mean of the distance ratio provides a point in the translation ratio distribution. FIG. 16 shows an example of such a translation ratio distribution, in which six pairs were used.

Refining the initial alignment may further involve obtaining the robust median value of the pair distance ratio distribution. An example of such a robust median value is shown for the translation ratio distribution shown in FIG. 16. In some implementations, this may involve performing a sigma-clipped statistical process at, e.g., 3 sigma, so that outliers that are ≥3 sigma are removed. This robust median value will be the scaling factor.

Refining the initial alignment may further involve applying a robust median value scaling factor. It should be noted that a standard deviation >0.1 may indicate that the world coordinate system positions and the estimated positions are very different, and the scale of the reconstruction has a high probability of error. Additionally, if more than 22% of the positions are considered outliers in the translation ratio distribution, then scaling issues are highly probable.

Refining the initial alignment may further involve performing a known iterative corresponding points (ICP) algorithm to refine the alignment between the world coordinate system image positions and the estimated positions <3 sigma.

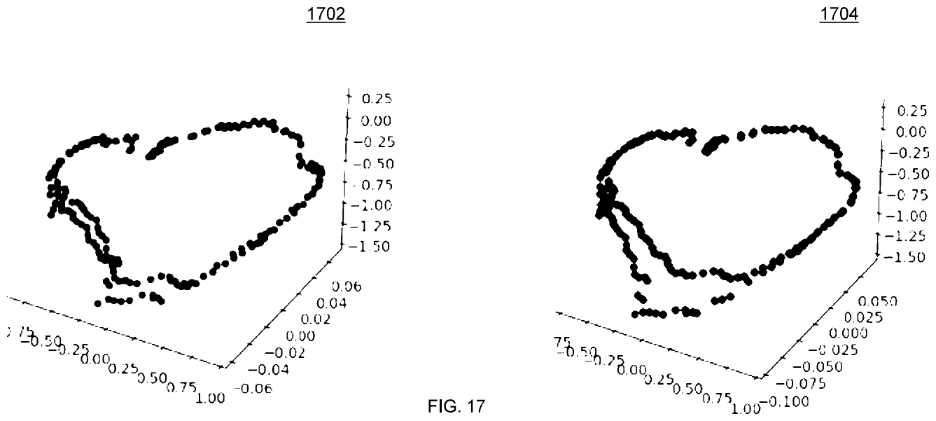

FIG. 17 shows an example of an alignment 1702 between world coordinate system image positions and estimated positions before application of an ICP algorithm, and an alignment 1704 between world coordinate system image positions and estimated positions after application of the ICP algorithm.

In some implementations, a scaling ICP method is used to refine the alignment between the world coordinate system indexed positions and the estimated indexed positions. In this method, the scale optimization operation is implicitly included within the process and the scaling factor will be obtained from the result of the process, providing the scaling factor that was applied for the alignment between corresponding points.

According to a full trajectory process in the scaling ICP method, the scaling ICP method aligns the world and estimated trajectory curves. This is an application of known ICP algorithms, and involves aligning two similar elements in 2D or 3D.

According to a single indexed pairs process in the scaling ICP method, a scaling ICP technique is applied on single pairs of same indexed cameras. In some implementations, the scaling ICP technique, applicable to two sets of one point, is applied to each corresponding pair of cameras, i.e. camera index iₚ from camera poses with corresponding camera iₑ from estimated cameras.

The scaling ICP method according to the described technology combines the full trajectory process as discussed above with the single indexed pairs process as discussed above.

In some implementations, one or both of the non-scaling and scaling ICP methods discussed above are employed. Results can be combined in different ways to obtain the scaling factor, including, e.g., considering the mean, the average, and/or the lowest or the highest values/scaling factors given through each approach.

In some implementations of the method 200 the clusters-of-interest module 204 may be performed by the at least one operation of geometric-based region growing 2042, and/or the at least one operation color-based region growing 2044. The at least one operation of geometric-based region growing 2042 may include any method known to those skilled in the art. The at least one operation of color-based region growing 2044 may include any color space known to those skilled in the art. In some implementations, color-based region growing may use an RGB color space. In some implementations, an HSV color space, or any other color space known to those of skill in the art may be used.

In some implementations of the method 200 the clusters-of-interest module 204 may be performed by the at least one operation of geometric-based region growing 2042. To better illustrate geometric-based region growing, several terms are defined with respect to this process.

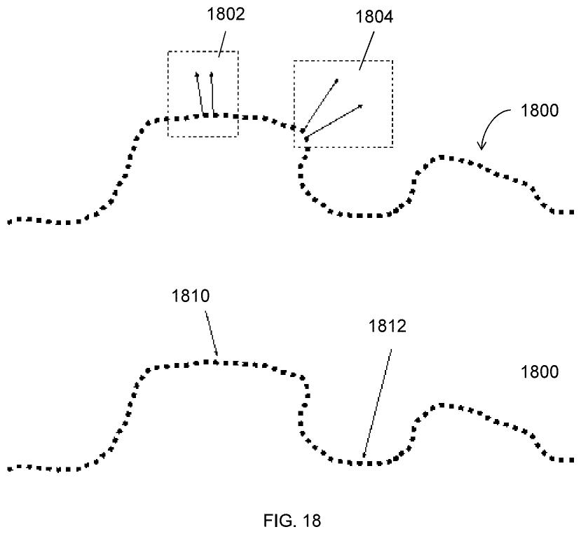

As used herein, a seed point is an initial reference point from which to begin a process. In the case of region growing segmentation, the seed point may be a point where a curvature is below a predetermined threshold (curvature is inverse of the curvature radius). In other words, seed points will generally belong to a flat area. This is illustrated in FIG. 18. As shown in FIG. 18, the region 1802 of the point cloud 1800 (shown here as a 2D representation for ease of understanding) has a low curvature, while the region 1804 has a high curvature. Points, such as the points 1810 and 1812, at which the curvature is low may be used as seed points.

As used herein an initial seed point is the reference point from which to begin the initial region growing process. In the case of region growing segmentation, the initial seed point will be the point with minimum curvature.

As used herein, a neighbor of a reference point is a point that is closer in distance to the reference point than a predetermined threshold. In some implementations, this threshold depends on the resolution of the point cloud, e.g. 5 times the resolution. In some implementations, neighbors may also be defined as the closest points to the reference point, and the number of neighbors (see neighborhood below) is set to a specific number, which may be, for example, a fraction of the total points in the point cloud, e.g. 1/1000 of the total points in the point cloud.

As used herein, the neighborhood of a reference point is a set of all the neighbors of the reference point that are within a predetermined distance threshold of a defined point, or where the number of neighbors is set to a predetermined number. This predetermined number can be defined as a fraction of the total points in the point cloud. In some implementations, this number can be defined by the average number of neighbors of each point in the point cloud according to a distance threshold.

As used herein, a geometrical region defined by a reference point is a set of points for which the angle between the normal vector of a point and the normal vector of the reference point is smaller than a predetermined threshold. In the discussion of geometric-based region growing 2042, a “region” will generally refer to a geometrical region, unless otherwise specified.

As used herein, an unlabeled point is a point that is not assigned or labeled to a region.

As used herein, a proximate region distance between two regions is defined by the smallest distance between a point in the first region and a point in the second region. In some implementations, regions may be considered neighbors if this distance is below a predetermined threshold.

As used herein, a small region threshold is a predetermined number of points below which a region is considered to be a “small” region. In some implementations, the predetermined number of points may be defined in relation to the total number of points in the point cloud. For example, in some implementations, the predetermined number of points may be 1/1000 of the total number of points in the point cloud.

As used herein, a too small region threshold is a predetermined number of points below which a region is considered to be “too small,” and may be removed from the process. In some implementations, the predetermined number of points may be defined in relation to the total number of points in the point cloud. For example, in some implementations, the predetermined number of points may be 1/10000 of the total number of points in the point cloud.

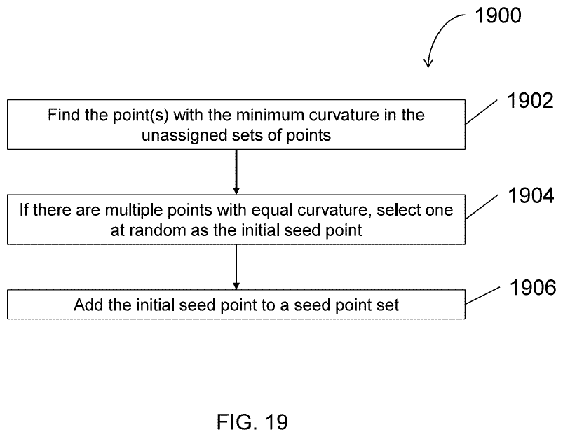

Having defined these terms, the geometric-based region growing 2042 is illustrated as block diagrams in FIGS. 19, 21, and 26. FIG. 19 shows a block diagram of a first portion 1900 of geometric-based region growing in a point cloud, in which initial seed points are defined.

At block 1902, the system finds the point in an unassigned set of points with the minimum curvature below the predefined threshold specified to define a seed point. At block 1904, if there are multiple points with equal curvature, one is selected at random as the initial seed point. At 1906, this point is added to a seed point set.

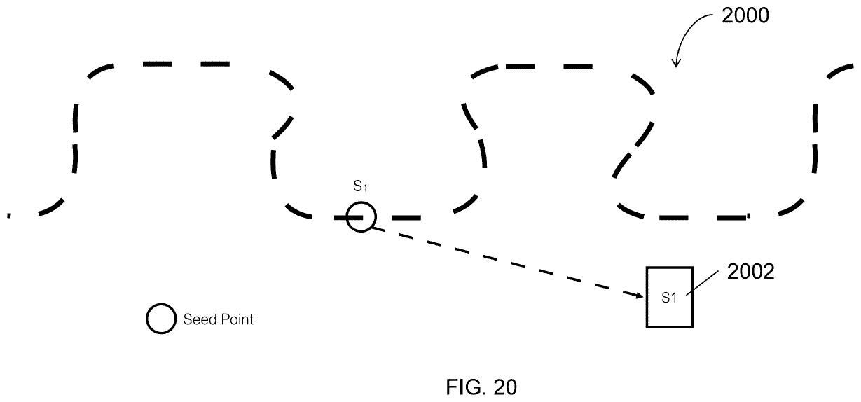

This process is further illustrated in FIG. 20, which shows a portion of a point cloud 2000 (shown in 2D for ease of understanding), in which numerous of the points (shown as short segments) have equally low curvature (i.e., numerous belong to “flat” portions of the point cloud 2000). Accordingly, one of these points, labeled S has been randomly selected as the initial seed point, and added to the seed point set 2002.

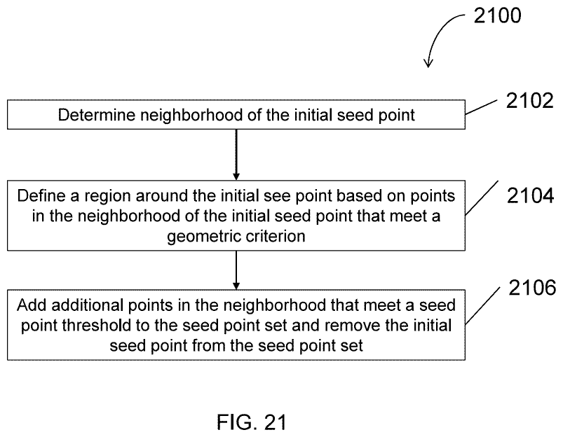

FIG. 21 shows a block diagram 2100 of a second portion of geometric-based region growing 2042. Continuing from the block diagram of FIG. 19, the block diagram of FIG. 21 starts after an initial seed point has been identified.

At block 2102, a neighborhood of the seed point is determined by finding the neighbor points for the initial seed point. This may be done in some implementations by finding all points that are within a predetermined distance threshold of the seed point. In some implementations, this may be done by finding a predetermined number of “closest” points to the seed point. This predetermined number may be determined, for example, as a fraction of total number of points in the point cloud (e.g., 1/1000 of the points). In some implementations, this number can be defined by the average number of neighbors of each point cloud according to a distance threshold. A neighborhood is defined as the set of neighbor points to the seed point.

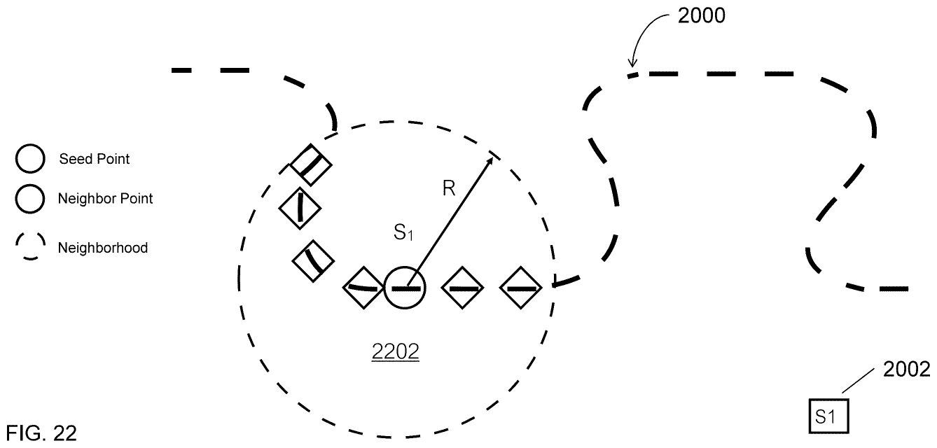

This is further illustrated in FIG. 22, which continues the illustration of FIG. 20. In FIG. 22, a neighborhood 2202 of the seed point S, is shown. In some implementations, the neighborhood 2202 can be defined by the set of neighbor points that are within a predetermined distance R of the seed point Sₗ. In some implementations, the neighborhood 2202 can be defined as a predetermined number of neighbor points closest to the seed point Sₗ—in this example, the nearest six points (or the nearest seven points if Sₗ is itself considered to be a “neighbor” point).

Referring back to FIG. 21, in block 2104, a region is defined around the seed point. In some implementations, the region may include the set of points from the neighborhood where the angle between the normal vector for a point in the neighborhood and the normal vector of the seed point is below a predetermined threshold. All the points in the neighborhood that meet this condition are assigned (or labeled) to the region.

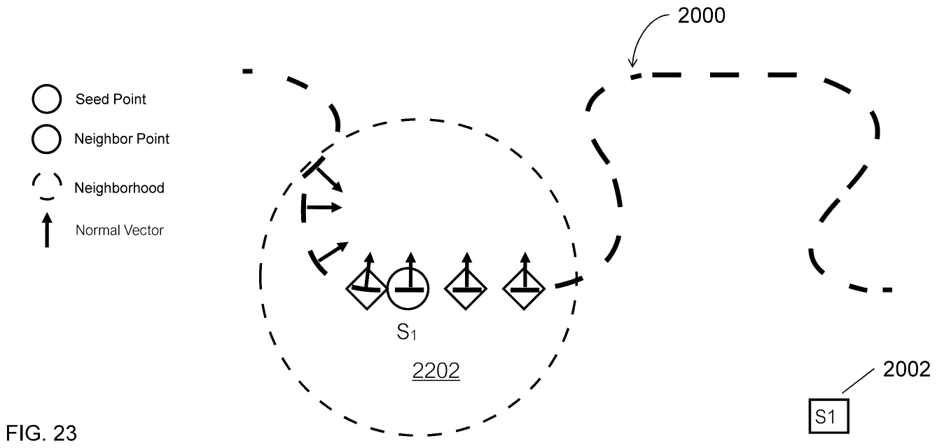

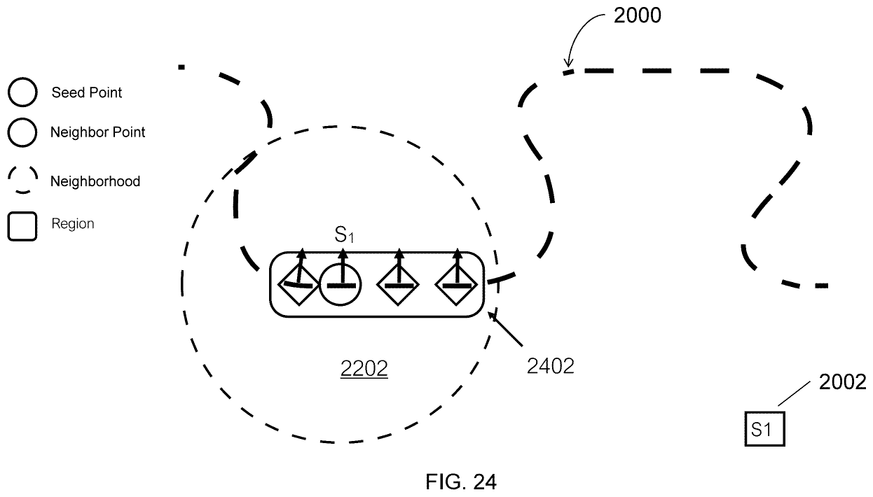

This is illustrated in FIGS. 23 and 24, which continue the illustration of FIG. 22. In FIG. 23, a normal vector for each of the points in the neighborhood 2202 is shown. FIG. 24 shows a region 2202 that includes only those points from the neighborhood 2202 that have an angle between the normal vector of the point in the neighborhood and the normal vector of the seed point that is below a threshold.

Referring again back to FIG. 21, at block 2106, additional points in the neighborhood that meet the seed point threshold (i.e., curvature below a predetermined threshold) are added to the seed point set, and the initial seed point is removed from the seed point set. After this block, a point can have a status of: 1. Belongs to the region (i.e., the point is “assigned”) and is a seed point; 2. Belongs to the region (i.e., is assigned) and is not a seed point; 3. Does not belong to the region (i.e., the point is “unassigned”) and is a seed point; or 4. Does not belong to the region (i.e., is unassigned) and is not a seed point.

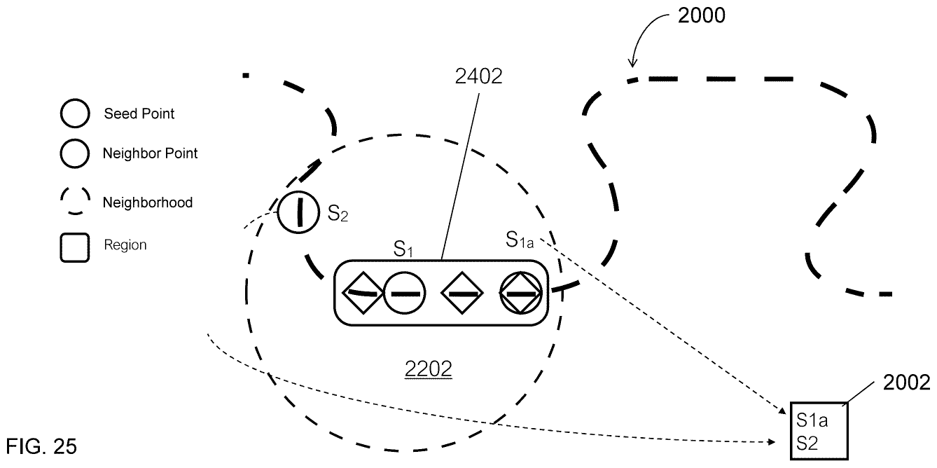

This is illustrated in FIG. 25, which continues the illustration of FIG. 24. In FIG. 25, two additional points in the neighborhood 2202 have been identified as meeting the seed point threshold. The first of these, labeled S₁ₐ, is in the region 2402, while the second point, labeled S₂ is in the neighborhood 2202, but not in the region 2402. As can be seen, the points S₁ₐ and S₂ have been added to the seed point set 2002, and the point S, has been removed from the seed point set 2002.

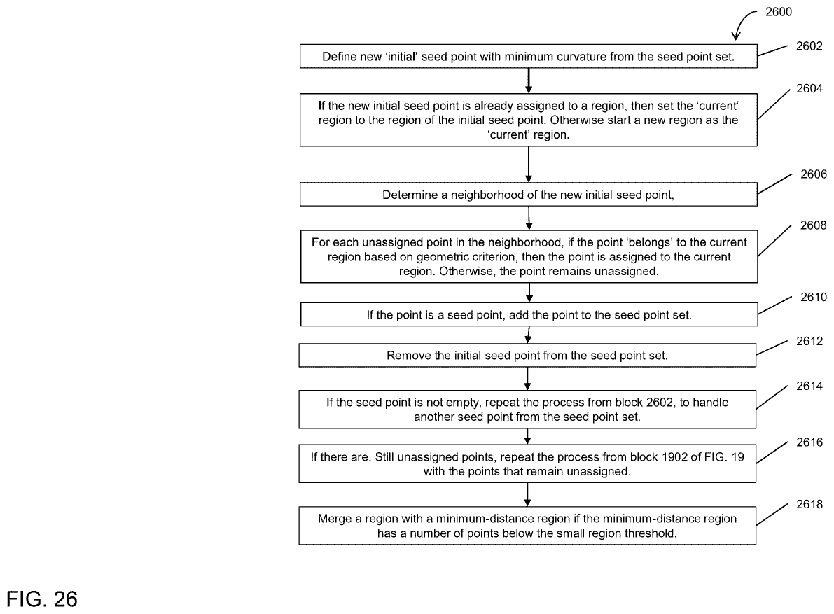

FIG. 26 shows a block diagram 2600 of a third portion of the segmentation process 2042, continuing the geometric-based region growing of FIGS. 19 and 21 with additional region growing. The additional region growing of the block diagram 2600 starts after the initial region growing of FIG. 21, and uses the seed point set that was defined in the initial region growing of FIG. 21. The additional region growing of the block diagram 2600 is repeated until the seed point set is empty.

At block 2602, the seed point with the minimum curvature (or maximum curvature radius) in the seed point set is defined as the “initial” seed point. If there are multiple points in the seed point set with equal curvature, one may be selected at random as the initial seed point.

At block 2604, if this initial seed point is already assigned to a region, then the “current” region is set to the region of the initial seed point, and that region may grow. Otherwise (i.e., the initial seed point is not already assigned to a region), then a new region may be created, and the “current” region is set to the new region.

At block 2606, a neighborhood of the initial seed point is defined. As before, this involves finding the neighbor points for the initial seed point, which may be done in some implementations by finding all points that are within a predetermined distance threshold of the initial seed point. In some implementations, this may be done by finding a predetermined number of “closest” points to the seed point. This predetermined number may be determined, for example, as a fraction of total number of points in the point cloud (e.g., 1/1000 of the points). In some implementations, this number can be defined by the average number of neighbors of each point cloud according to a distance threshold. A neighborhood is defined as the set of neighbor points to the seed point.

At block 2608, for each unassigned point in the neighborhood, if the point “belongs” to the current region, then the point is assigned to the current region. Otherwise, the point remains unassigned. As before, the point belongs to the current region if the angle between the normal vector for the point and the normal vector of the seed point is below a predetermined threshold.

At block 2610, if the point is a seed point (i.e., the curvature at the point is less than a predetermined threshold), then the point is added to the seed point set.

At block 2612, the initial seed point is removed from the seed point set.

At block 2614, if the seed point set is not empty, then the process is repeated from block 2602, to handle another seed point from the seed point set.

At block 2616, if the seed point set is empty, but there are still unassigned points, then the process may start again from the beginning (i.e., block 1902 of FIG. 19) with the points that are still unassigned. In some implementations, if this point is reached again with no change to the unassigned points, then the process may simply continue. In some implementations, prior to starting again with the unassigned points, the threshold for defining a seed point may be incrementally adjusted, so that more of the unassigned points may be added to the seed point set.

In some implementations, the process includes a block 2618, which may merge a region with a minimum-distance region if the minimum-distance region has a number of points below the small region threshold. This effectively eliminates the consideration of “small” regions. In some implementations, regions may be removed from the point cloud if they contain a number of points below the “too small region threshold” (e.g., 1/10000 of the points in point cloud).

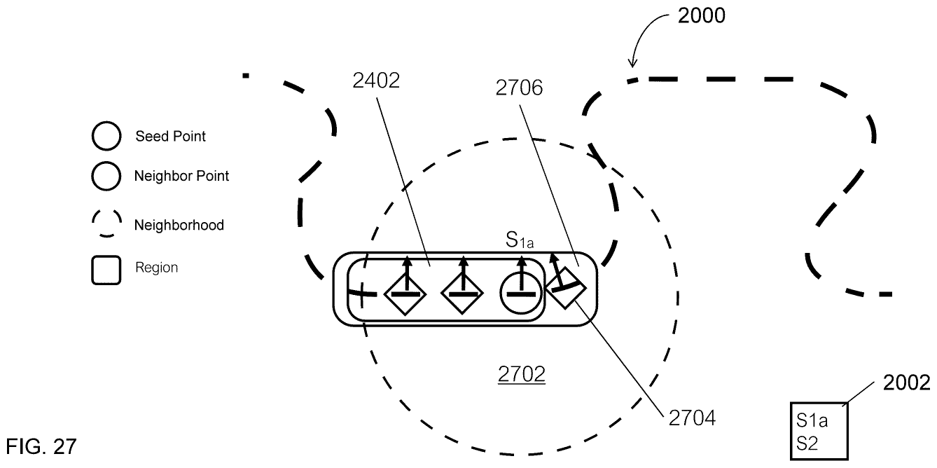

FIGS. 27-29 illustrate the process shown in FIG. 26, continuing the illustration of FIG. 25. In FIG. 27, the seed point S₁ₐ has been selected as the “initial” seed point. Because the seed point S₁ₐ is assigned to the region 2402, so the region 2402 will be set as the “current” region, and may be expanded to include neighbor points to the seed point Sla that meet the criterion for being included in a region, based on the angle between the normal vector of the point and the normal vector of the seed point Sla. The points in the neighborhood 2702 of the seed point Sla that meet this criterion are shown with normal vectors in FIG. 27. Of these, the neighbor point 2704 is not already assigned to the region 2402, so the region 2402 will be expanded to include the neighbor point 2704. This is shown as the expanded region 2706.

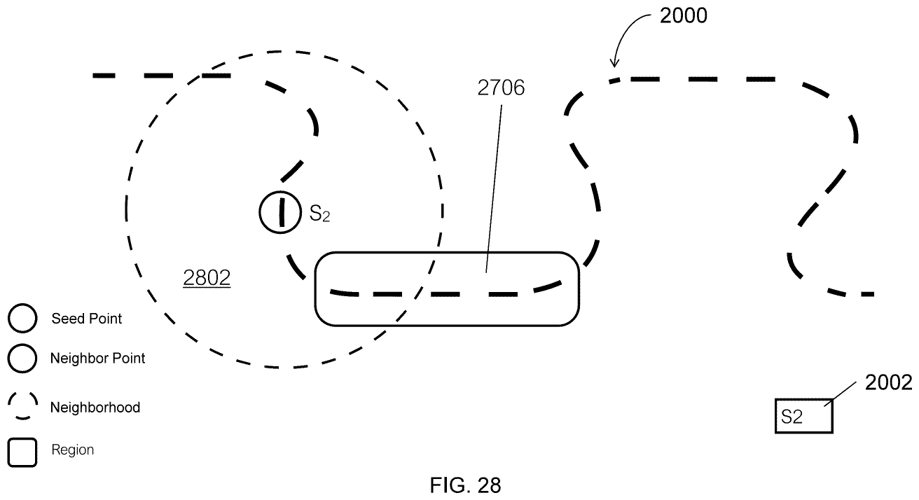

In FIG. 28, the point S₁ₐ has been removed from the seed point set 2002, and the seed point S₂ has been selected as the new “initial” seed point. Because the initial seed point S₂ is not already assigned to a region, a new region will be started, and will be set as the “current” region. FIG. 28 also shows the neighborhood 2802 of the seed point S₂, based on a predefined distance from the initial seed point S₂.

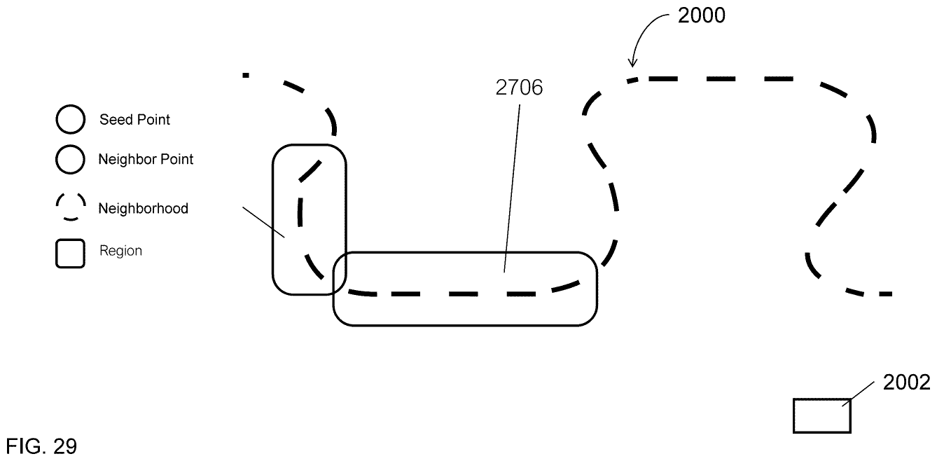

FIG. 29 shows the expanded region 2706, and a new region 2902. The expanded region 2706 includes five points, while the new region 2902 includes only three points. If the small region threshold is five points, then the expanded region 2706 has a size at or above the small region threshold, while the new region 2902 has a size that is below the small region threshold. In some implementations, this means that the expanded region 2706 and the new region 2902 may be merged into a single region (having eight points).

In some implementations of the method 200 the clusters-of-interest module 204 may be performed by the at least one operation of color-based region growing, wherein the at least one color distance is used to determine which points in a neighborhood belong to a region. To determine color distances, the input point cloud include color information for each point in the point cloud. In some implementations, this color information may be defined in a Red-Green-Blue (RGB) color space. In some implementations, the color information may be defined in a Hue-Saturation-Value (HSV) color space, or in any other color space known by those of ordinary skill in the art. Conversion of color coordinates of the points between color spaces may be performed using known techniques. Because there may be at least approximate mappings between different color spaces, in some implementations, it is not necessary for all the points in the point cloud to include color information defined in the same color space.

While most of the terms defined above with respect to geometric-based region growing 2042 keep the same meaning in the clustering process, there are some additional terms defined here.

As used herein, the color distance between two points depends on the color space that is used in the implementation. For example, for implementations using the RGB color space, the color distance may be determined as a Euclidian distance between the colors. For a first point having a color (R₁, G₁, B₁) and a second point having a color (R₂, G₂, B₂), this can be calculated as:

$$\sqrt{{( {R}_{2} - {R}_{1} )}^{2} + {( {G}_{2} - {G}_{1} )}^{2} + {( {B}_{2} - {B}_{1} )}^{2}} .$$

If another color space is used, the color distance can be defined according to known distance measures in that color space.

As used herein, a color-based region is a set of points where the color distance to a defined point (e.g., a seed point) is below a predetermined threshold. In the following discussion of the second color-based region growing 2044, a “region” will generally refer to a color-based region.

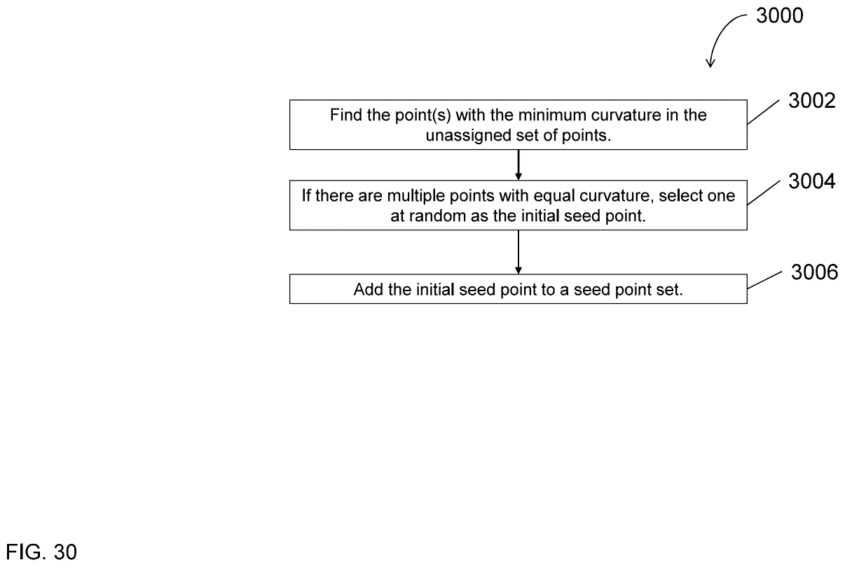

Having defined these terms, color-based region growing 2044 is illustrated in block diagrams in FIGS. 30-32. FIG. 30 shows a block diagram of a first portion 3000 of color-based region growing in a point cloud, in which initial seed points are defined.

At block 3002, the system finds the point in an unassigned set of points with the minimum curvature below the predefined threshold specified to define a seed point. At block 3004, if there are multiple points with equal curvature, one is selected at random as the initial seed point. At block 3006, this point is added to a seed point set.

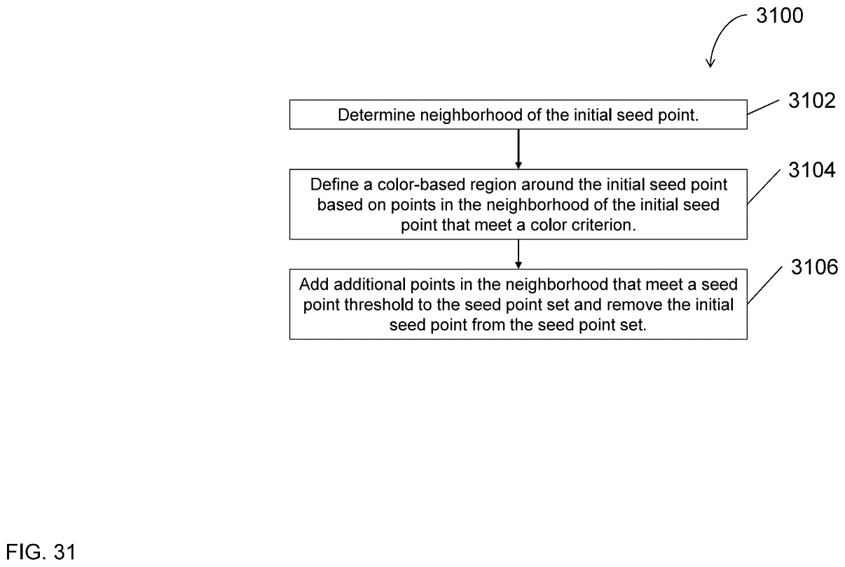

FIG. 31 shows a block diagram 3100 of a second portion of the second segmentation process 2044, continuing the color-based region growing of FIG. 30 with initial region growing. Continuing from the block diagram of FIG. 30, the block diagram of FIG. 31 starts after an initial seed point has been identified.

At block 3102, a neighborhood of the seed point is determined by finding the neighbor points for the initial seed point. This may be done in some implementations by finding all points that are within a predetermined distance threshold of the seed point. In some implementations, this may be done by finding a predetermined number of “closest” points to the seed point. This predetermined number may be determined, for example, as a fraction of total number of points in the point cloud (e.g., 1/1000 of the points). In some implementations, this number can be defined by the average number of neighbors of each point cloud according to a distance threshold. A neighborhood is defined as the set of neighbor points to the seed point.

In block 3104, a color-based region is defined around the seed point. In some implementations, the region may include the set of points from the neighborhood where the color distance from a point in the neighborhood and the seed point is below a predetermined threshold. All the points in the neighborhood that meet this condition are assigned (or labeled) to the region.

At block 3106, additional points in the neighborhood that meet the seed point threshold (i.e., curvature below a predetermined threshold) are added to the to the seed point set, and the initial seed point is removed from the seed point set.

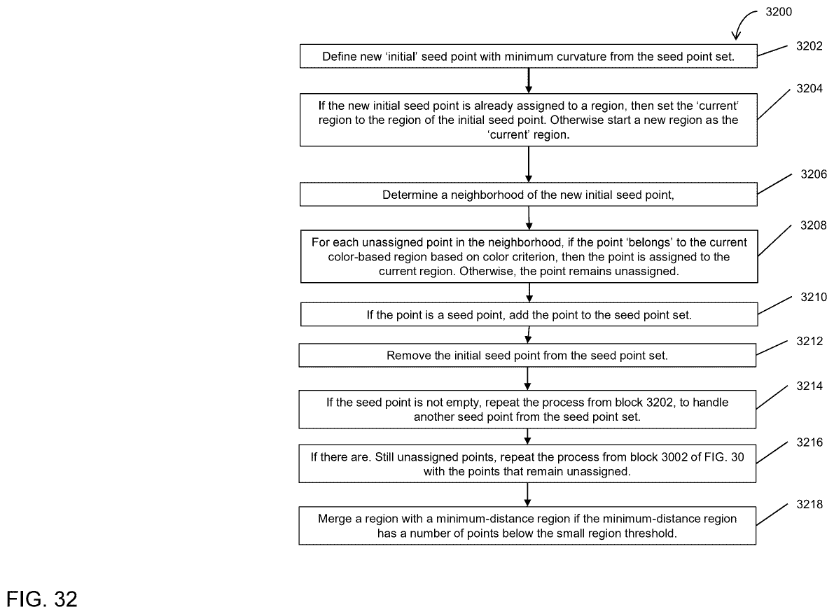

FIG. 32 shows a block diagram 3200 of a third portion of the second color-based region growing 2044, continuing the color-based region growing of FIGS. 30 and 31 with additional region growing. The additional region growing of the block diagram 3200 starts after the initial region growing of FIG. 31, and uses the seed point set that was defined in the initial region growing of FIG. 31. The additional region growing of the block diagram 3200 is repeated until the seed point set is empty.

At block 3202, the seed point with the minimum curvature (or maximum curvature radius) in the seed point set is defined as the “initial” seed point. If there are multiple points in the seed point set with equal curvature, one may be selected at random as the initial seed point.

At block 3204, if this initial seed point is already assigned to a region, then the “current” region is set to the region of the initial seed point, and that region may grow. Otherwise (i.e., the initial seed point is not already assigned to a region), a new region may be created, and the “current” region is set to the new region.

At block 3206, a neighborhood of the initial seed point is defined. As before, this involves finding the neighbor points for the initial seed point, which may be done in some implementations by finding all points that are within a predetermined distance threshold of the initial seed point. In some implementations, this may be done by finding a predetermined number of “closest” points to the seed point. This predetermined number may be determined, for example, as a fraction of total number of points in the point cloud (e.g., 1/1000 of the points). In some implementations, this number can be defined by the average number of neighbors of each point cloud according to a distance threshold. A neighborhood is defined as the set of neighbor points to the seed point.

At block 3208, for each unassigned point in the neighborhood, if the point “belongs” to the current region, then the point is assigned to the current region. Otherwise, the point remains unassigned. As before, the point belongs to the current region if the color distance between the point and the seed point is below a predetermined threshold.

At block 3210, if the point is a seed point (i.e., the curvature at the point is less than a predetermined threshold), then the point is added to the seed point set.

At block 3212, the initial seed point is removed from the seed point set.

At block 3214, if the seed point set is not empty, then the process is repeated from block 3202, to handle another seed point from the seed point set.

At block 3216, if the seed point set is empty, but there are still unassigned points, then the process may start again from the beginning (i.e., block 3002 of FIG. 30) with the points that are still unassigned. In some implementations, if this point is reached again with no change to the unassigned points, then the process may simply continue. In some implementations, prior to starting again with the unassigned points, the threshold for defining a seed point may be incrementally adjusted, so that more of the unassigned points may be added to the seed point set.

In some implementations, the process includes a block 3218, which may merge a region with a minimum-distance region if the minimum-distance region has a number of points below the small region threshold. This effectively eliminates the consideration of “small” regions. In some implementations, regions may be removed from the point cloud if they contain a number of points below the “too small region threshold” (e.g., 1/10000 of the points in point cloud).

Once regions (either geometrical or color-based) have been defined, the regions may be merged into clusters, and clusters-of-interest may be identified. This is handled in the cluster-of-interest operation 205.

In some implementations of the method 200, the cluster-of-interest operations module 205 may employ the process 3500 to obtain the at least one object-of-interest 206.

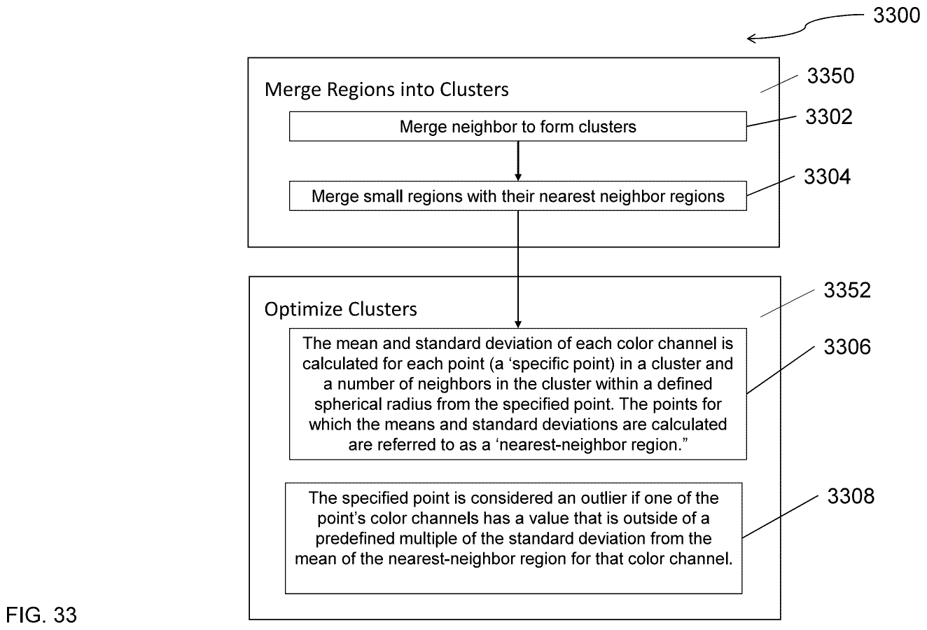

Referring now to FIG. 33, a block diagram 3300 of a process 3350 for merging regions into clusters and a process 3352 for optimizing clusters through statistical color outlier filtering are described. It will be understood that in some implementations, other processes could be used for optimizing clusters, and that the process 3352 for optimizing clusters that is shown in FIG. 33 requires color information on the points in the point cloud.

The process 3350 for merging regions into clusters includes blocks 3302 and 3304. At block 3302, neighbor regions are merged to form clusters. Neighbor regions are regions in which the distance between regions—i.e., the smallest distance between any two points, each point exclusive to one of the regions—is below a predetermined threshold (see the definition of “proximate region distance” above). Two regions may be merged if: (1) the difference between the average color of the first region and the average color of the second region is below a predetermined threshold; and (2) the two regions are neighbor regions.

At block 3304, in some implementations, any small regions (see above) may be merged with its nearest neighbor region. In some implementations, too small regions (see above) may be deleted from the point cloud.

The process 3352 for optimizing clusters through statistical color outlier filtering includes blocks 3306 and 3308. It should be noted that in the examples shown below, an RGB color space is used, but it will be understood that this is only for illustration. In some implementations, color outlier filtering may use an RGB color space. In some implementations, an HSV color space, or any other color space known to those of skill in the art may be used.

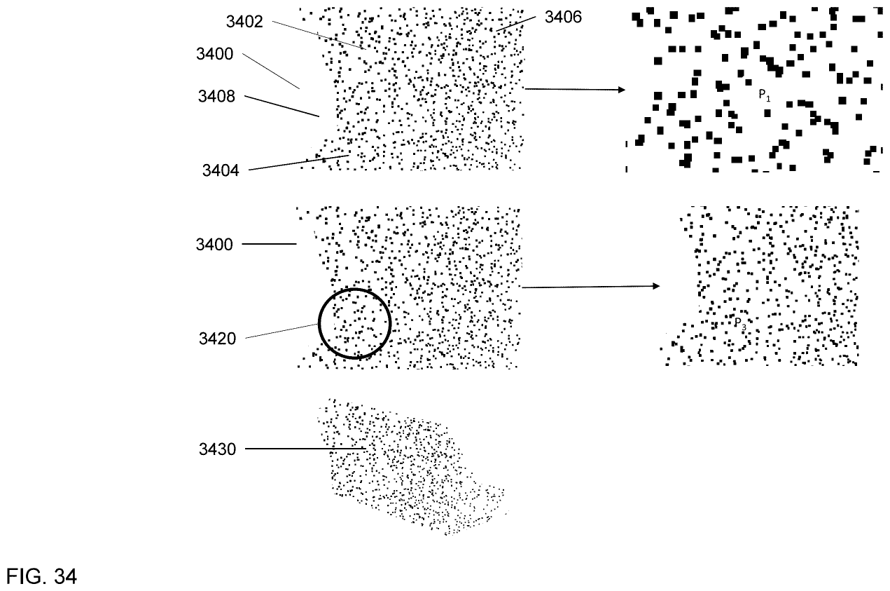

At block 3306, the mean and standard deviation of each color channel is calculated for each point (a “specified point”) in a cluster and a number of neighbors in the cluster within a defined spherical radius from the specified point. The points for which the means and standard deviations are calculated are referred to as a “nearest neighbor region.” In some implementations, the number of neighbors may be, for example, 4*K neighbors, where K is the mean number of points inside the volume of a defined radius. In some implementations, this defined radius may be a multiple of the resolution, such as 5*Resolution. This is illustrated in FIG. 34, which shows (as 2D circles, for clarity) the 5*Resolution radius around a first point 3402 and a second point 3404, and K would be calculated as the mean number of points within this radius.

Referring back to FIG. 33, at block 3308, the specified point is considered an outlier if one of the point's color channels has a value that is outside of a predefined multiple of the standard deviation from the mean of the nearest neighbor region for that color channel. For example, in some implementations, if the difference between the R, G or B color and the mean value of the nearest neighbor region of the specified point is greater than twice the standard deviation of the nearest neighbor region, the point is considered as an outlier. In some implementations, such outlier points may be removed as “noise.”

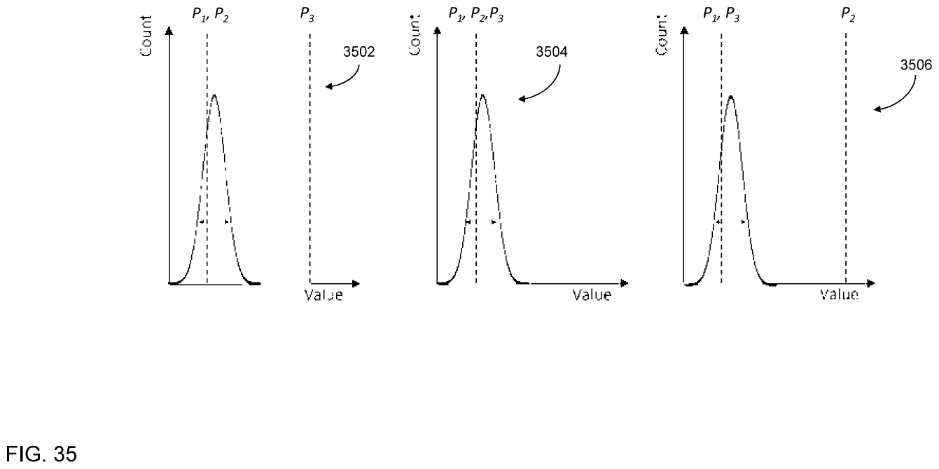

This is illustrated in FIGS. 34 and 35 for statistical outlier filtering to obtain optimized clusters. In FIG. 34, a neighborhood 3400 includes a predominately black cluster 3402, a predominately red cluster 3404, a predominately green cluster 3406, and a predominately blue cluster 3408. The black cluster 3402 is the “main” cluster. A point P₁ (shown, for clarity, in a scaled-up view of a portion of the neighborhood 3400), which is a black point in the black cluster 3402, is not at outlier, and will not be removed as noise. Another view of the neighborhood 3402 shows an example 4*K neighborhood 3420, as discussed above. Two additional points, P₂ and P₃ (shown, for clarity, in a scaled-up view of a portion of the neighborhood 3400) are outliers, as will be discussed below. Finally, FIG. 34 shows a denoised main cluster of interest 3430, following application of statistical color outlier filtering.

FIG. 35 shows color distributions of the neighborhood 3400, discussed above with reference to FIG. 34, including a red distribution 3502, a green distribution 3504, and a blue distribution 3506. The mean and two times the standard deviation are shown in each distribution, for reference. As shown, P₁ and P₂ have red values that are within two times the standard deviation of the mean in the red distribution 3502. All of P₁, P₂, and P₃ have green values that are within two times the standard deviation of the mean in the green distribution 3504. P; and P₃ have blue values that are within two times the standard deviation of the mean in the blue distribution 3506. Thus, only P, has all of its color components within two times the standard deviation of the mean for the various color distributions, so P₁ is not an outlier. By contrast, P₂ has a blue component that is outside of two times the standard deviation from the mean of the blue distribution 3506, and P₃ has a red component that is outside of two times the standard deviation from the mean of the red distribution 3502, so both P₂ and P₃ are deemed to be outliers.

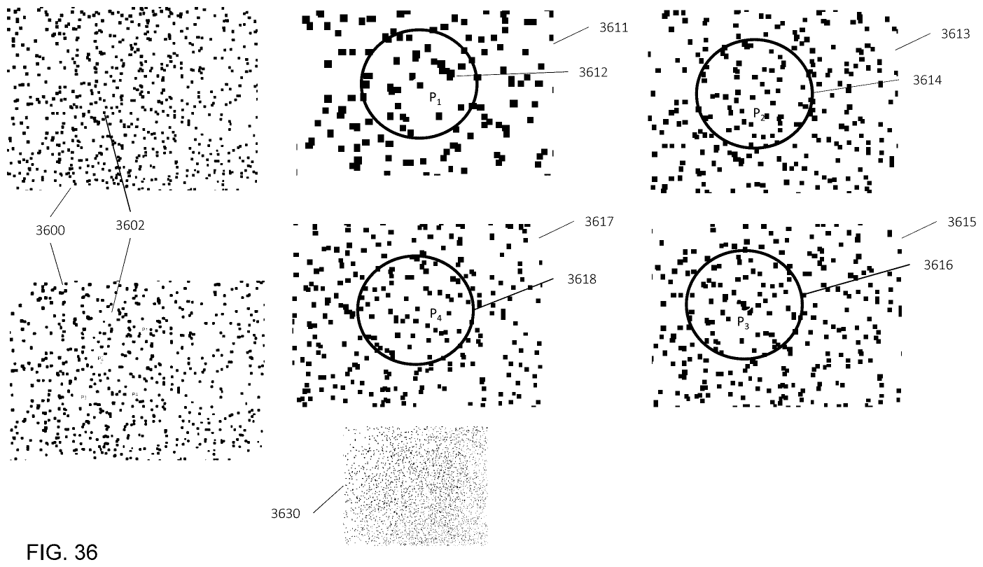

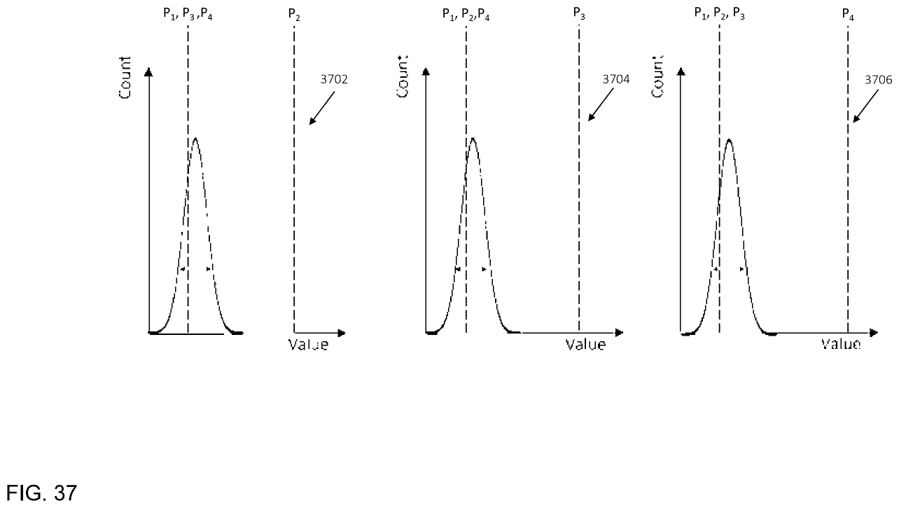

FIGS. 36 and 37 show the same procedure used for fine outlier filtering. In FIG. 36, a neighborhood 3600 includes a predominately black cluster 3602, which is the “main” cluster, but that includes noise having a variety of other colors. A point P₁ (shown, for clarity, in a scaled-up view of a portion of the neighborhood 3600), which has a 4*K neighborhood 3612, is a black point the black cluster 3602, and is not an outlier. A point P₂ (shown, for clarity, in a scaled-up view of a portion of the neighborhood 3600), which has a 4*K neighborhood 3614, is a red point in the black cluster 3602, and is an outlier. A point P₃ (shown, for clarity, in a scaled-up view of a portion of the neighborhood 3600), which has a 4*K neighborhood 3616, is a green point in the black cluster 3602, and is an outlier. A point P₄ (shown, for clarity, in a scaled-up view of a portion of the neighborhood 3600), which has a 4*K neighborhood 3618, is a blue point in the black cluster 3602, and is an outlier. Finally, FIG. 36 shows a denoised main cluster of interest 3630, following application of statistical color outlier filtering.

FIG. 37 shows color distributions of the neighborhood 3600, discussed above with reference to FIG. 36, including a red distribution 3702, a green distribution 3704, and a blue distribution 3706. The mean and two times the standard deviation are shown in each distribution, for reference. As shown, P₁, P₃, and P₄ have red values that are within two times the standard deviation of the mean in the red distribution 3702. P₁, P₂, and P₄ have green values that are within two times the standard deviation of the mean in the green distribution 3704. P₁, P₂, and P₃ have blue values that are within two times the standard deviation of the mean in the blue distribution 3706. Thus, only P, has all of its color components within two times the standard deviation of the mean for the various color distributions, so P₁ is not an outlier. By contrast, P₂ has a red component that is outside of two times the standard deviation from the mean of the red distribution 3702, P₃ has a green component that is outside of two times the standard deviation from the mean of the green distribution 3704, and P₄ has a blue component that is outside of two times the standard deviation from the mean of the blue distribution 3706, so P₂, P₃, and P₄ are deemed to be outliers.

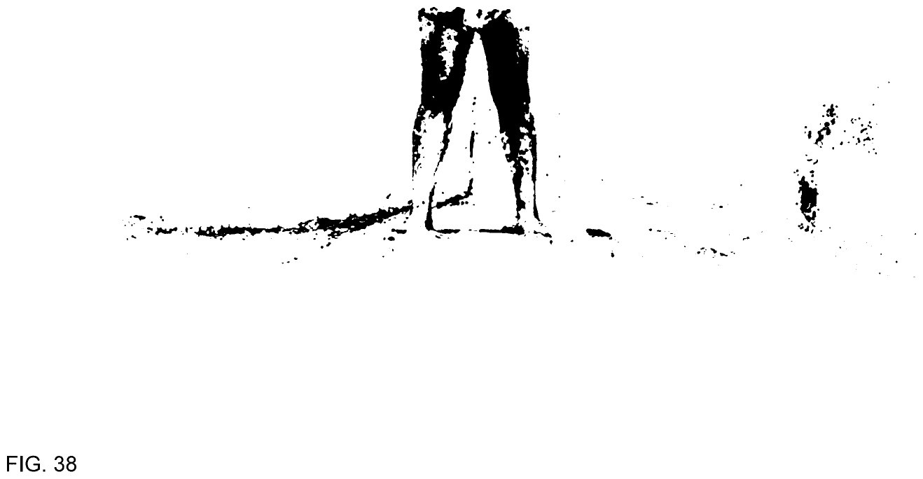

FIG. 38 shows a “raw” point cloud with colors. The point cloud includes legs, a floor, and a considerable amount of noise, which may, e.g., include points on surrounding walls, etc.

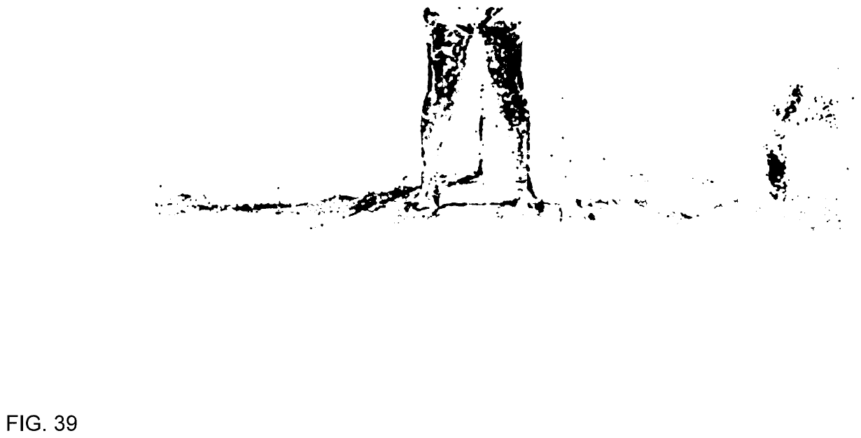

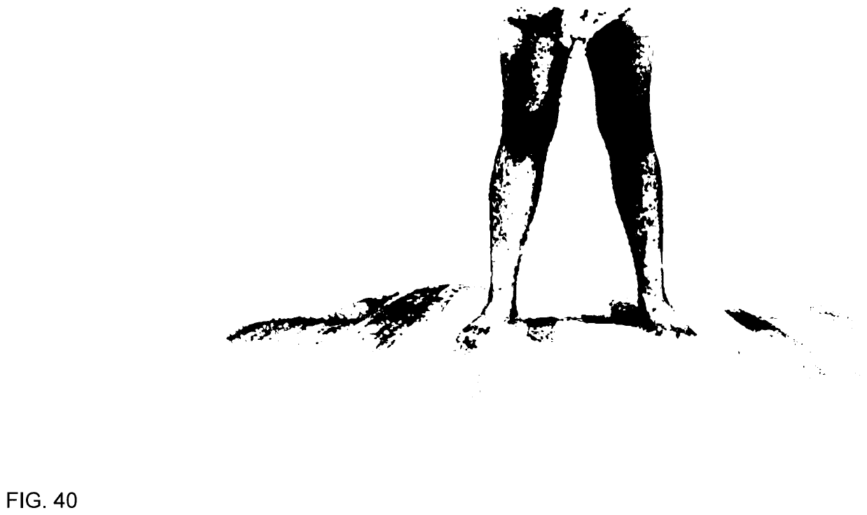

FIG. 39 shows color-based outliers, as determined using, e.g., the de-noising processes described above. Removing these outliers results in the filtered point cloud shown in FIG. 40. As seen in FIG. 40, the filtered point cloud still includes legs and a portion of a floor. In the second de-noising process, planar surfaces, such as the floor, are removed. Such planar surfaces may, for example, be surfaces beneath or adjacent to an object, or surfaces on which an object is resting.

It will be understood that the features and examples above are not meant to limit the scope of the present disclosure to a single implementation, as other implementations are possible by way of interchange of some or all of the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific implementations so fully reveals the general nature of the disclosure that others can, by applying knowledge within the skill of the relevant art(s) (including the contents of any documents cited and incorporated by reference herein), readily modify and/or adapt for various applications such specific implementations, without undue experimentation and without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phrascology of the present specification is to be interpreted by the skilled artisan in light of the teachings and guidance presented herein, in combination with the knowledge of one skilled in the relevant art(s).

While the above-described implementations have been described and shown with reference to particular steps performed in a particular order, it will be understood that these steps may be combined, sub-divided, or re-ordered without departing from the teachings of the present technology. The steps may be executed in parallel or in series. Accordingly, the order and grouping of the steps is not a limitation of the present technology.

While various implementations of the present disclosure have been described above, it should be understood that they have been presented by way of example, and not limitation. It would be apparent to one skilled in the relevant art(s) that various changes in form and detail could be made therein without departing from the spirit and scope of the disclosure. Thus, the present disclosure should not be limited by any of the above-described implementations, but should be defined only in accordance with the following claims and their equivalents.

1. A computer-implemented method for extracting an object-of-interest from a 3D point cloud prior to performing 3D operations onto the extracted object-of-interest, the 3D point cloud comprising a plurality of data points, the method comprising:
accessing the 3D point cloud:
in response to identifying a planar surface within the 3D point cloud:
identifying first data points that define the planar surface from the 3D point cloud:
identifying second data points for which a distance to the planar surface is below a first distance threshold;
identifying third data points for which a color distance to the planar surface is below a second distance threshold; and
removing the first, second and third data points from the 3D point cloud to create pre-curated 3D point cloud clusters;
for each of the pre-curated 3D point cloud clusters, determining a corresponding cluster parameter, the corresponding cluster parameter being calculated based on a number of data points of the given 3D point cloud cluster, a location of a center of mass of the given 3D point cloud cluster, and a resolution of the given 3D point cloud cluster;
identifying the object-of-interest based on the calculated cluster parameters; and
performing 3D operations on the object-of-interest.

2. The computer-implemented method of claim 1, wherein performing 3D operations on the object-of-interest comprises performing geometric measurements thereon.

3. The computer-implemented method of claim 1, wherein performing 3D operations on the object-of-interest comprises morphing the object-of-interest onto a 3D model.

4. The computer-implemented method of claim 1, wherein a color distance between two data points is measured by comparing H-channel values within a Hue Saturation Value (HSV) color space of the two data points.

5. The computer-implemented method of claim 1, wherein removing the first, second and third data points from the 3D point cloud to create pre-curated 3D point cloud clusters comprises:
in response to a distance between two pre-curated 3D point cloud clusters being below a third distance threshold, merging the two pre-curated 3D point cloud clusters into a same pre-curated 3D point cloud cluster.

6. The computer-implemented method of claim 5, wherein the distance between two pre-curated 3D point cloud clusters is a color distance.

7. The computer-implemented method of claim 1, wherein identifying the object-of-interest based on the calculated cluster parameters comprises:
identifying a pre-curated 3D point cloud cluster having a highest cluster parameter; and
removing the other pre-curated 3D point cloud clusters from the 3D point cloud.

8. The computer-implemented method of claim 1, wherein determining a corresponding cluster parameter comprises:
determining a resolution of the pre-curated 3D point cloud cluster by:
determining, for each data point of the pre-curated 3D point cloud cluster, a neighbor distance to a nearest neighbor data point within the pre-curated 3D point cloud cluster; and
determining an average of the neighbor distances of the data points of the pre-curated 3D point cloud cluster.

9. The computer-implemented method of claim 1, further comprising applying a statistical outlier removal process prior to determining a corresponding cluster parameter for each of the 3D point cloud clusters.

10. The computer-implemented method of claim 1, wherein identifying a planar surface within the 3D point cloud comprises identifying a surface in the 3D point cloud that is perpendicular to a reference axis.

11. The computer-implemented method of claim 1, further comprising, prior to removing the first data point from the 3D point cloud:
determining a main normal vector of the planar surface; and
in response to an angular difference between a local normal vector at a given data point of the first data points and the main normal vector being above an angular threshold, excluding the given data points from the first data points.

12. The computer-implemented method of claim 1, wherein the planar surface is a ground planar surface.

13. The computer-implemented method of claim 1, wherein the cluster parameter is defined by:
(number of points within cluster)/(cluster mass center×cluster resolution).

14. The computer-implemented method of claim 1, further comprising, prior to identifying the first data points, defining a search area within the 3D point cloud for searching the planar surface.

15. The computer-implemented method of claim 14, wherein defining the search area comprises:
determining a bounding box of the 3D point cloud;
defining the search area as a portion of the bounding box.

16. The computer-implemented method of claim 15, wherein the search area is a lower portion of the bounding box.

17. The computer-implemented method of claim 14, wherein defining the search area comprises:
determining a bounding box of the 3D point cloud;
determining a delimiting sphere having a center at a center of mass of the 3D point cloud, a radius of the delimiting sphere being determined based on a dimension of the bounding box;
defining the search area as an intersection of the bounding box and an exterior of the delimiting sphere.

18. The computer-implemented method of claim 1, further comprising removing a pre-curated 3D point cloud cluster from the 3D point cloud in response to a number of data points of the pre-curated 3D point cloud cluster being below a data point threshold.

19.-21. (canceled)

22. A computer-implemented method for removing a planar surface from a 3D point cloud, the 3D point cloud comprising a plurality of data points, the method comprising:
accessing the 3D point cloud;
identifying a planar surface within the 3D point cloud;
identifying first data points that define the planar surface from the 3D point cloud;
identifying second data points for which a distance to the planar surface is below a first distance threshold;
identifying third data points for which a color distance to the planar surface is below a second distance threshold; and
removing the first, second and third data points from the 3D point cloud to create pre-curated 3D point cloud clusters.

23.-30. (canceled)

31. A computer-implemented method for identifying an object-of-interest from a 3D point cloud, the 3D point cloud comprising a plurality of data points, the method comprising:
accessing the 3D point cloud;
defining at least one cluster of data points;
for each of the at least one cluster, determining a corresponding cluster parameter based on a number of data points of the cluster, a location of a center of mass of the cluster with respect to a reference point of the 3D point cloud, and a resolution of the cluster; and
identifying the object-of-interest based on the calculated cluster parameters.

32.-39. (canceled)
